(19) United States
(12) Patent Application Publication
(10) Pub. No.: US 2006/0106699 A1
(43) Pub. Date: May 18, 2006

(54) System and method for conducting secure commercial order transactions

(76) Inventors: Boris Hitalenko, Buffalo Grove, IL (US); Michael Likterev, Buffalo Grove, IL (US)

Correspondence Address: Edward Etkin, Esq., Suite 3C, 4804 Bedford Avenue, Brooklyn, NY, 11235, US

(21) Appl. No.: 10/992,532

(22) Filed: Nov. 17, 2004

(51) Int. Cl. G06Q 40/00

(52) U.S. Cl. 705/35

(57) ABSTRACT

The inventive system and method enable secure remote commercial order transactions between customers and merchants. The inventive system and method ensure that customer entire confidential financial data (CFD) is never transmitted to the merchant by keeping that CFD proprietary to the customer's exiting financial service provider (FSP) with which the customer has established a financial account, and from which the merchant is authorized to receive payments. When an order is placed, the customer provides to the merchant a partial CFD (PCFD) sufficient, along with additional data, to identify the FSP to the merchant, and to identify the customer to the FSP. The merchant then provides the PCFD, along with at least partial order data, to the FSP, and order confirmation data (OCD) to the customer. Various embodiments of a novel order verification process are also provided that enable authorization, by the customer, of the order through contact between the customer and the FSP. In this manner, the complete CFD is kept absolutely secure as it never leaves the possession of the customer and the FSP. Optionally, the FSP is given the opportunity to offer additional services and/or products to the customer during order authentication, that are related or unrelated to the order. Advantageously, the inventive system and method function equally well for interactive electronic (e.g., online) orders, telephone orders, mobile commerce orders, facsimile orders, mail-order orders, and even in-person orders.

### FIELD OF THE INVENTION

The present invention relates generally to a system for enabling commercial transactions that may occur remotely, for example, over one or more communication networks, and more particularly to a data processing and communication system for enabling customers placing orders with merchants to conduct secure payment transactions therewith.

### BACKGROUND OF THE INVENTION

The development of the Internet as an enabler for information, communication, efficiency and commerce over the past decade has been an advance that is unparalleled in our society. In commerce, in particular, over two hundred billion dollars have been spent on Internet purchases (by consumers and businesses) in the last year alone, and there is no end in sight for the continued dramatic growth that is expected in the coming years. The proliferation of relatively inexpensive and powerful personal computers, as well as ready availability of inexpensive high speed Internet access, have further fueled the already rapid expansion of commercial services available to consumers over the Internet. In parallel, cable and satellite service providers, which in the past have only provided media content, began to offer interactive capabilities to their subscribers that in certain cases enable the subscribers, utilizing a provided “set-top box” or equivalent device, to conduct commercial transactions. At the same time, conventional mail-order, facsimile, and telephone-based commercial transactions (and especially non-interactive television-based home shopping) have declined somewhat but certainly not to the degree commensurate with the expected decline due to the proliferation of on-line ordering capabilities.

Notwithstanding the tremendous growth in availability of on-line offerings of products and services, there has been a very significant challenge (and in some cases, barrier) to continued success and growth of on-line commerce—the escalating growth of fraudulent on-line transactions. It is well documented that currently nearly 10% of every dollar spent in on-line transactions represents the costs involved in combating fraud. On-line fraud can take many forms, but is generally defined as utilization of consumer confidential financial data (CFD) (e.g., credit card number, expiration date, CVV2 number, etc), by an unauthorized party to engage in on-line commercial transactions or for related purposes.

But fraudulent on-line transactions are only a part of the problem—the true risk of on-line commerce, as perceived by most consumers, is the theft, or misappropriation, of consumer CFD that may later be used not only to place fraudulent on-line orders, but also for other secondary purposes, such as placing off-line fraudulent mail, facsimile, or telephone orders, in addition to being utilized as a basis for even more dangerous activities, such as identity theft. Furthermore, recent increased scrutiny of methods used by various terrorist organizations to obtain funds, equipment and supplies has demonstrated that such organizations frequently engage in fraudulent on-line transactions, CFD misappropriation, and identity theft.

Theft or misappropriation of CFD has always been a problem with conventional telephone (e.g., catalog or television shopping network based orders), and mail-order or facsimile-based commercial transactions, because the customer was forced to provide the CFD verbally to an employee of the merchant, or in writing by sending the CFD as part of an order form through facsimile or by conventional mail. In both cases, the CFD was readily accessible to parties that may intercept or misappropriate and then utilize the CFD for fraudulent purposes. While in certain areas on-line transactions may offer a greater deal of security for transmission of CFD between a customer and a merchant, the challenge of CFD theft by individuals with external or internal accesses to the merchants' computer systems remains. In fact, as described below, the process of on-line commercial transactions offers even more opportunities for CFD misappropriation than do other non-electronic methods.

Theft or misappropriation of the CFD may occur in at least one or more of the following well known and publicized ways:
Interception of the CFD from consumer prior to transmission: Many consumers store their CFD on their computer as part of “form-filling” software or in simple text or word processing files for their convenience. In this case, any individual who is able to gain electronic or physical access to the consumer's computer may be able to obtain the CFD. In another case, a computer virus infecting the consumer's computer, such as a “keystroke logger” or a password capture program, may be able to intercept the CFD being entered by the consumer during an order process, and then secretly send it to a third party;
Interception of the CFD during transmission: For example, the CFD may be misdirected from a merchant's system, the consumer may be tricked into sending the CFD to a different destination (i.e., “spoofing”), the CFD may be intercepted at the merchant side by a maliciously installed hidden program, etc.
Theft of the CFD from the merchant: The CFD may be misappropriated by the merchant, by one or more of the merchants' employees, or by a third party breaking into a merchant's customer CFD database.

In recent years, a great number of approaches and technologies have been introduced and/or proposed to reduce the incidence of fraudulent on-line transactions. Generally, these solutions are split into several categories, with certain solutions falling into more than one category:
CFD Protection (e.g., encryption of CFD data before, during, and/or after transmission);
Consumer Identity Verification (e.g., verification that the individual placing an on-line order is in fact the consumer to whom the CFD belongs, as accomplished through software using consumer-entered security codes, through hardware, such as biometric (fingerprint, retina, palm, voice pattern) scanners, key cards and readers, global positioning systems, or via a combination of both software and hardware technologies); and
Use of Secure Third Party Agents (e.g., an third party organization that securely holds the CFD and that communicates with and acts as an intermediary between, the customer, the merchant and the customer's financial service provider (FSP), so that the CFD is never sent to the merchant directly.

However, all of the above approaches suffer from a number of disadvantages that make them cumbersome, expensive, impractical, or otherwise difficult to implement:
Required changes in current commercial transaction infrastructure, (which is virtually impossible or impractical), or that add a significant per-transaction expense, such as use of third party secure agents;
Required special software and/or hardware for one or more of the involved parties (i.e., customer, merchant, FSP, etc.). One popular recently offered approach requires a biometric sensor (such as a fingerprint scanner) to be utilized by the customer in conjunction with a software program installed on the customer's computer. Prior to conducting an online transaction, the customer's identity was authenticated by the biometric device. However, this approach requires customers to purchase expensive hardware and to deal with complex biometric software, and has thus failed to capture consumer confidence and approval; and
Requiring the customer to memorize any passwords, codes, PIN numbers.

In addition, most of the previously known solutions are limited to on-line transactions only, and thus cannot be utilized to address fraud issues in other types of purchase transactions (e.g., telephone, facsimile, or mail order transactions).

Unsurprisingly, criminal parties have kept up with technical developments, finding new ways to steal CFD, or to utilize misappropriated CFD to engage in on-line and other types of fraud. This resulted in banks and other financial institutions having to provide added assurances (promises of insurance coverage for fraud and identity theft) to appease the worried public, while at the same time steadily increasing the cost-per-transaction. Nevertheless, the vast majority of consumers are still wary of making on-line purchases, and while the growth of Internet commerce is very impressive, it is still far from its maximum potential.

It is well believed that consumer confidence in on-line commerce cannot be readily elevated until there is a cost effective, simple, and secure way to: (1) prevent misappropriation of CFD resulting from on-line commercial transactions; and/or (2) to verify that an online order for which payment to a merchant is required from a specific customer's financial service provider, was in fact placed by the customer.

It would thus be desirable to provide a system and method for easily and inexpensively enabling customers to conduct highly secure commercial transactions with remote merchants, without requiring special dedicated equipment, and utilizing currently existing commercial transactions infrastructure. It would also be desirable to provide a system and method for completely eliminating the possibility if theft of CFD during commercial transactions between customers and merchants, and that are advantageous in all types of remote transactions such as on-line, telephone, facsimile and mail order.

### BRIEF DESCRIPTION OF THE DRAWINGS

In the drawings, wherein like reference characters denote corresponding or similar elements throughout the various figures:

FIG. 1 is a block diagram showing components of a first exemplary embodiment of the inventive secure order transaction system that may be advantageously utilized for placing product and/or service orders on-line, or through any other type of interactive service;

FIG. 2 is a process flow chart showing an exemplary embodiment of a novel process for performing commercial order transactions remotely utilizing the system of FIG. 1;

FIG. 3 is a set of block diagrams showing components of various data items generated in conjunction with the performance of the process of FIG. 2;

FIG. 4 is a process flow chart showing an exemplary embodiment of a novel order verification process that is performed in conjunction with the process of FIG. 2;

FIG. 5 is a process flow chart showing an exemplary alternate embodiment of the novel order verification process of FIG. 4;

FIG. 6 is a block diagram showing components of a second exemplary embodiment of the inventive secure order transaction system that may be advantageously utilized for placing orders by use of voice communication devices (for example, via conventional or mobile telephones);

FIG. 7 is a block diagram showing components of a third exemplary embodiment of the inventive secure order transaction system that may be advantageously utilized for placing orders through a wireless service provider utilizing a mobile communication device;

FIG. 8 is a process flow chart showing an exemplary embodiment of a novel process for performing commercial transactions remotely utilizing the system of FIG. 7;

FIG. 9 is a set of block diagrams showing components of various data items generated in conjunction with the performance of the process of FIG. 8;

FIG. 10 is a process flow chart showing an exemplary embodiment of a novel order verification process that is performed in conjunction with the process of FIG. 8;

FIG. 11 is a block diagram showing components of a fourth exemplary embodiment of the inventive secure order transaction system that may be advantageously utilized for placing orders through transmission of a written order form;

FIG. 12 is a process flow chart showing an exemplary embodiment of a novel process for performing commercial transactions remotely utilizing the system of FIG. 7; and

FIG. 13 (Prior Art) is a block diagram showing elements of an exemplary previously known common order transaction process utilized for placing remote orders online, via communication devices, or through transmission of written order forms.

### SUMMARY OF THE INVENTION

The present invention is directed to a system and method for enabling secure remote commercial order transactions, that through various embodiments described below, advantageously address and meet both of the major security challenges currently facing remote commercial order transactions: (1) theft of confidential financial data (CFD), and (2) verification that the individual placing a remote order using particular CFD, is in fact the person to whom the CFD belongs, or who has otherwise been authorized to use the CFD.

The present invention accomplishes the above goals by: (1) ensuring that the complete CFD is never transmitted to the merchant, and in fact is not even necessary for order placement, and by: (2) separating the order process into the stages of order placement and order verification, where the verification of the order is made by the customer's financial service provider (FSP)—a party that has always been in possession of the customer's CFD. Advantageously, the inventive system and method also provide FSPs with the opportunity to offer one or more products and/or services to the customer during the order verification process, and also with a unique opportunity to offer certain services when customers are in dire need thereof (e.g., credit line increases, loans, etc.).

In summary, the inventive system and method enable secure commercial order transactions between customers and merchants, over at least one communication link (which may range from one or more communication networks to the postal mail system, depending on the inventive embodiment thereof. The inventive system and method ensure that customer entire CFD is never transmitted to the merchant, by keeping that CFD proprietary to the customer's exiting FSP with which the customer has an established financial account, that has previously issued a payment instrument (e.g., credit card, debit card, check card, etc.) to the customer, with which the CFD is associated, and that is capable or transmitting (or authorizing transmission of), payments to a merchant's financial account.

In the various embodiments of the present invention, when an order is placed, the customer provides to the merchant a partial CFD sufficient, along with additional data, also provided as part of the order, to identify the customer's FSP to the merchant, and to identify the customer to the FSP. The merchant then provides the partial CFD, along with at least partial order data, to the FSP and also provides order confirmation data to the customer. The specific way in which the order and the partial CFD are transmitted from the customer to the merchant (i.e., the order component of the novel system) depends on the specific inventive embodiment thereof, while the financial operations performed between the merchant and the FSP (and related parties) remain substantially identical for the different inventive embodiments.

Various embodiments of a novel order verification process are also provided, that enable authorization, by the customer, of the order through contact between the customer and the FSP. In one embodiment, contact to authenticate the order is initiated by the customer who contacts their FSP, in another embodiment, the FSP contacts the customer when the at least partial order data along with the partial CFD have been received from the merchant. The exact manner in which the inventive order verification process occurs is preferably pre-arranged between the customer and their FSP.

In accordance with the present invention, the FSP is provided with the ability to offer additional services and/or products to the customer during the novel order verification process, related, or unrelated to, the order. Advantageously, the inventive system and method function equally well for interactive electronic (e.g., online) orders, telephone orders, mobile commerce orders, facsimile orders, electronic mail orders, and mail-order orders.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims.

### DETAILED DESCRIPTION OF PREFERRED EMBODIMENTS

The system and method of the present invention remedy the disadvantages of previously known systems for enabling secure commercial transactions between customers and merchants. The present invention in its various embodiments, in contrast to most recently developed secure transaction techniques (which are focused only on securing on-line transactions), functions equally well for virtually all types of commercial transactions—whether one initiated by electronic orders sent over one or more communication networks (such as the Internet and/or local or long-distance telephone networks), or ones initiated by other types of contact with merchants, for example, by telephone, facsimile or through the mail. Advantageously, the system and method of the present invention enable customers to conduct secure order transactions with any type of merchant without requiring any special software, encryption, or special hardware on the part of the customer, the merchant, or the financial transaction processor. And, unlike many previously known systems, the inventive system and method do not require utilization of a costly third party (e.g., a secure agent or secure data repository) to manage and limit the flow of the customer's confidential financial data (CFD) between the customer and the merchant. Thus, the present invention provides all of its beneficial features without changing the existing transaction infrastructure.

In essence, the inventive system and method accomplish the above goals by ensuring that the customer's entire confidential financial data (CFD) is never transmitted to the merchant, and is preferably retained by a highly secure party (or parties) that the user has already previously authorized (directly or implicitly) to securely handle their commercial transactions (for example by signing up for a particular credit card, the customer provides transaction handling authorization to the issuing bank). Such secure pre-authorized parties may include, but are not limited to, a credit or debit card company, a bank, a brokerage, a financial management firm, etc., or any combination thereof. For the sake of simplicity, these parties are generically referred to herein, individually and collectively, as financial service providers (hereinafter “FSPs”). As they are currently implemented, most commercial transactions involve one or more additional highly secure parties that work in conjunction with the FSPs and that are responsible for actually handling the processing of the transactions submitted to the FSPs by the merchants (i.e., transaction processing companies (hereinafter “TPCs”)), and/or that are responsible for facilitating the portion of commercial transactions involving actually making payments to the merchants (i.e., financial transaction intermediaries (hereinafter “FTIs”)).

In accordance with the present invention, when a customer places an order with a merchant, in addition to the commonly transmitted order information (customer identifying information, a list of the products and/or services ordered, etc.) the merchant only receives a portion of the customer's CFD that is sufficient, in conjunction with at least a portion of the order information, to identify the specific customer to that customer's FSP (and/or to the corresponding TPC depending on how a particular FSP is structured). The provision, by the merchant, of the customer's order and partial CFD information to the FSP, enables the FSP to verify (through one or more novel processes disclosed below in connection with the various inventive embodiments) that the order has in fact been placed by the customer identified by the merchant. Once the order is verified, the remainder of the transaction proceeds in the previously known manner—e.g., the FSP authorizes payment for the order to the merchant, and the corresponding FTI transmits payment to the merchant.

In this manner, the CFD never leaves the possession of the only parties (i.e., customers and their FSPs) that already have a previously established relationship which involves the CFD. Thus, for example, a credit card CFD may include the credit card number (hereinafter the “CCN”), the expiration date, the card verification value “CVV2” or equivalent, and/or the name, address and/or the phone number of the issuing bank. Then, if the customer uses a credit card (issued by their FSP—a bank) to place an order with a merchant, the only portion of the CDF that is transmitted to the merchant along with the order information, may be the first digit, and the last four digits of the CCN, and the name of the issuing bank.

This information, along with the customer's name, address, and phone number is sufficient to enable the merchant to identify the customer to the FSP to initiate the order verification process, but cannot be misused in any way by the merchant, their employees or any unauthorized third parties who somehow obtain this information (such as by intercepting it during its transmission, or by misappropriating it from the merchant). Optionally, in the inventive embodiments of the present invention that relate to electronic order placement, the full CFD may not even be stored or entered by the customer at the electronic device used for order placement, such that even if a third party has somehow gained unauthorized access to the device used for order placement (for example, physically, by electronic intrusion, through a virus, a keystroke logger, or through any other illegal or unauthorized means), they would only be able to gain partial CFD information. Partial CFD information, is insufficient to enable unauthorized parties to utilize it to engage in fraudulent activities, because previously known order transaction systems require the full CFD, while the novel order verification process of the inventive system would expose and prevent any such attempts.

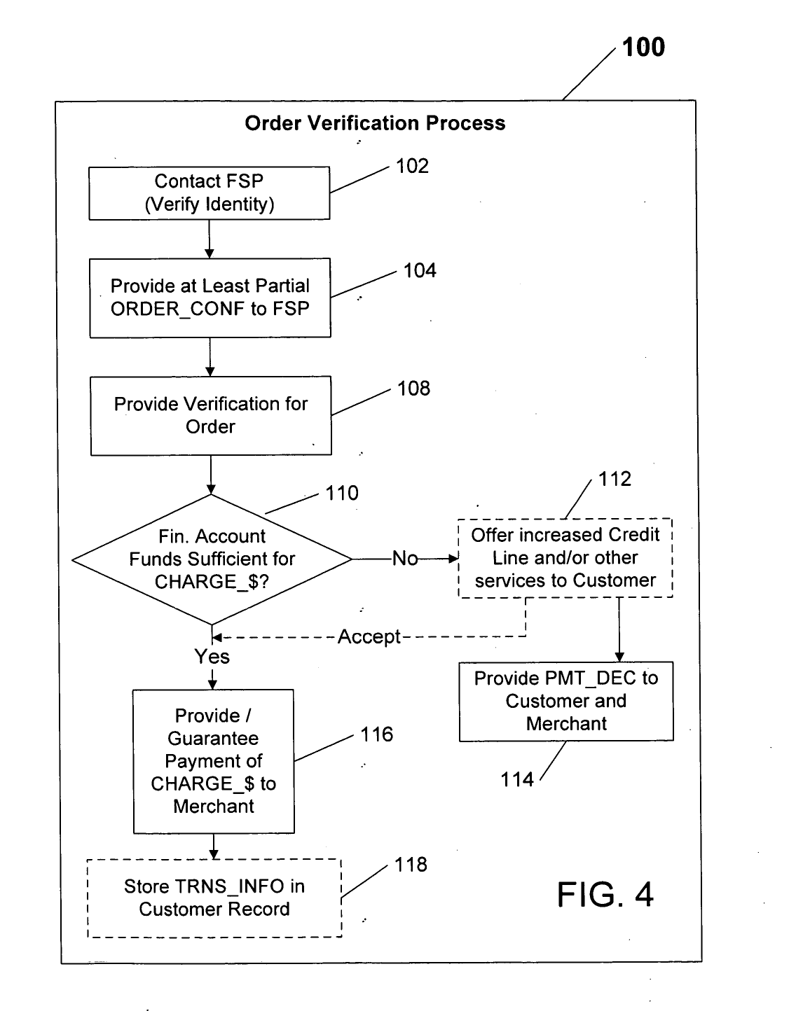

In addition to enabling truly secure order transactions in a variety of commercial environments (e.g., from electronic, to telephone, to mail order) without requiring changes or additions to the current established commercial transaction infrastructure, the inventive system and method advantageously enable the FSPs to derive many additional direct and indirect benefits from this process, for example by offering additional products and/or services (or upgrades thereto) to the customer during the order verification process. In certain cases, as described below in connection with FIGS. 4, 5, and 10, the inventive system and method enable the FSPs to offer unprecedented customer service benefits, as a matter of course, or as part of a premium membership program, such as offering to increase the customer's credit limit in situations where it is exceeded by the order charges, or allowing the customer time to make a payment to the credit account prior to charging it for the order, rather than automatically declining the transaction, and inconveniencing both the customer and the merchant, as is the current practice in such situations.

It should be understood to one skilled in the art that, unless explicitly indicated to the contrary, the various well-known terms are utilized below, in conjunction with the description of the various embodiments of the inventive system and method, by way of example only and in a generic and/or interchangeable manner. These terms are thus used herein in their broadest possible meaning, so as to encompass any equivalents thereof, and should not be interpreted so as to impose limitations of any kind on the disclosed features of any of the embodiments of present invention. For the purposes of clarity and convenience, general definitions of at the key terms, relevant to the inventive system and method, that are utilized herein in the manner described above, are provided in Table 1 “General Term Definitions”, below.

TABLE 1
(General Term Definitions)

| Term | Definition |
|---|---|
| Customer | An individual that has the ability and the intention to place an |
| | order with a merchant and that has a financial account with an |
| | FSP from which a payment for the order may be made to the merchant |
| Merchant | An individual or organization that provides products and/or |
| | services to customers in exchange to payments therefore, and |
| | that is able and authorized to receive payments from FSPs of the customers |
| Order | A request by a customer to a merchant for provision of a product |
| | and/or service thereto in exchange for a payment |
| FSP | Any organization that provides its customers with a financial |
| (Financial | account, with a payment instrument associated therewith, from |
| Service | which payments to merchants may be authorized by the |
| Provider) | customer utilizing the payment instrument. (Examples: a credit |
| | card company, a debit card company, a bank, a brokerage, etc.) |
| Payment | Any form of a financial instrument issued by a FSP to a customer |
| Instrument: | (directly or indirectly), that may be utilized by the customer to |
| | authorize the FSP and affiliate organizations (e.g., TPC, FTI, etc.) |
| | to make a payment on behalf of the customer to parties |
| | designated by the customer (i.e., merchants). The manner in |
| | which this purpose is accomplished, and other aspects of |
| | utilization may vary depending on specific type of instrument. |
| | Examples of financial instruments include, but are not limited to: |
| | a credit card, a charge card, a debit card, a cash card, or an |
| | equivalent thereof. Other equivalents of the above instruments, |
| | that provide a customer with certain CFD linked to an account |
| | through, or from, which the customer is able to authorize |
| | payments, are likewise contemplated. Thus, for example, even |
| | certain types of gift certificates that have a unique number |
| | specific to a certificate that is linked to a particular consumer may be utilized |
| | as payment instruments |

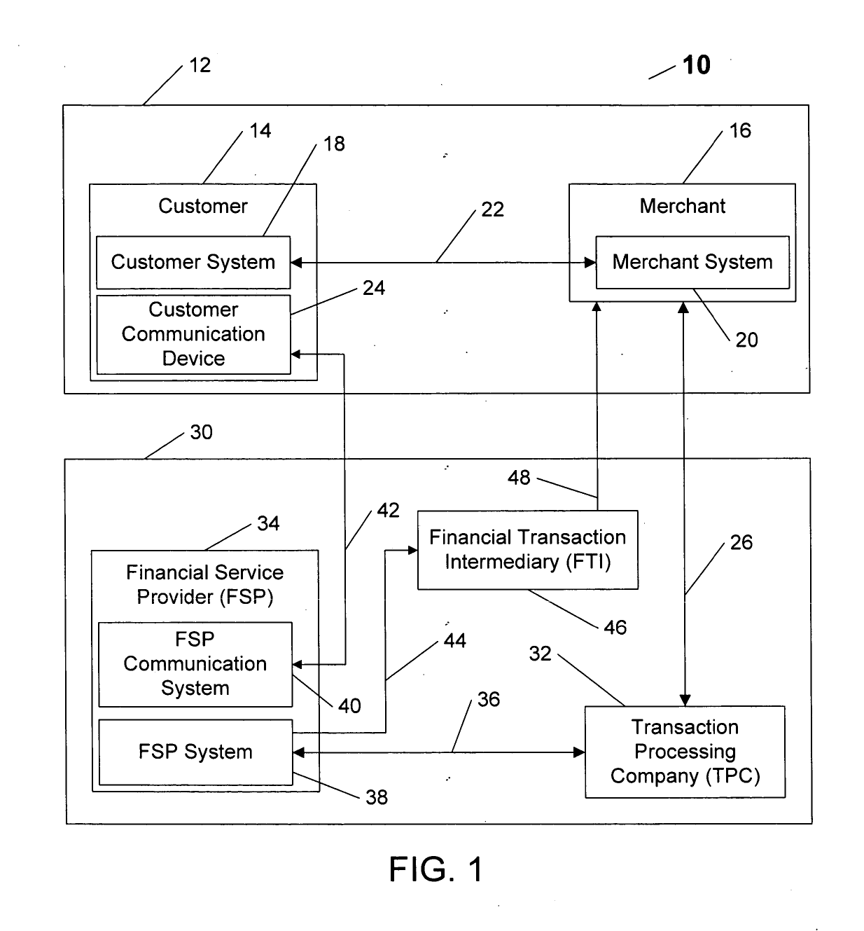

In addition, because of numerous abbreviations used in FIGS. 1 to 12 and accompanying descriptions thereof, Table 2 below provides a useful definition guide to the terms and abbreviations used in the respective figures.

TABLE 2
(Abbreviated Terms in FIGs. 1-12 and Accompanying Descriptions)

| Term | Definition |
|---|---|
| FSP | Financial Service Provider |
| TPC | Transaction Processing Company |
| FTI | Financial Transaction Intermediary |
| PURCH_DATA | Purchase information that is sent to the merchant when the |
| | customer places the order, and may include CUST_INFO, PMT_INFO, |
| | and P/S_LIST |
| CUST_INFO | Customer information that represents, for example, the |
| | customer's billing and shipping addresses, contact |
| | information, shipping preferences, and other similar |
| | information |
| PMT_INFO | Payment information, representative of a portion of the |
| | customer's CFD, related to the customer's payment |
| | instrument associated with the customer's financial account |
| | with a specific FSP, that is sufficient to identify the |
| | customer's specific FSP to the merchant, as well as to |
| | identify the customer and their payment instrument to their |
| | specific FSP, but that is insufficient to be used by a third |
| | party to engage in unauthorized activities |
| P/S_LIST | Product/Service List - the list of one or more products |
| | and/or services that the customer is ordering from the |
| | merchant |
| ORDER_DATA | All information related to the customer's order that is |
| | generated by the merchant (e.g., by the merchant's order |
| | system) based on PURCH_DATA and other parameters, and |
| | may include (in addition to PURCH_DATA): MERCH_ID, CHARGE_$, |
| | PMT_INFO, and ORDER_ID |
| MERCH_ID | The unique identification code that identifies the merchant to |
| | the FSP, the TPC, and to the customer |
| CHARGE_$ | The required payment amount for the customer's order |
| | including shipping and all other fees |
| ORDER_ID | The unique identification code assigned to the order by the |
| | merchant that identifies the order to the merchant, the FSP, |
| | the TPC, and the customer |
| PREL_APP | Preliminary Approval - the initial authorization received from |
| | the FSP by the merchant if the funds to which the customer's |
| | financial account has access are sufficient to cover the |
| | CHARGE_$ |
| PMT_DEC | Payment Declined - a notification provided by the FSP to the |
| | merchant, if the funds to which the customer's financial |
| | account has access are not sufficient to cover the |
| | CHARGE_$ |
| ORDER_CONF | Order Confirmation - a notification provided by the merchant |
| | to the customer that is sufficient to enable the customer to |
| | identify the order, for example when verifying to the FSP that |
| | the order was in fact placed by the customer, and may |
| | include one or more of: MERCH_ID, ORDER_ID, P/S_LIST, |
| | CHARGE_$, PP_INFO and ORDER_INFO. Optionally, the |
| | ORDER_CONF is only provided to the customer if |
| | PREL_APP was previously received by the merchant from |
| | the FSP |
| PP_INFO | Partial Purchase Information - information that is at least |
| | partially derived from the PURCH_DATA, and that is |
| | provided by the merchant to the customer as part of the |
| | order confirmation process |
| ORDER_INFO | Any additional order information (estimated shipping time, |
| | etc.) that is provided by the merchant to the customer as part |
| | of the order confirmation process |
| TRNS_INFO | Transaction information - the information about the entire |
| | order process that may be stored by the merchant and/or the |
| | FSP |
| WSP | Wireless Service Provider - an organization that provides |
| | wireless communication and other services (such as access |
| | to mobile commerce merchants) to customers, who are |
| | typically also service subscribers |
| MCM | Mobile Commerce Merchant - a merchant, that in |
| | conjunction with a WSP, offers products and/or services to |
| | customers that access the WSP utilizing mobile telephones |
| MP_DATA | Purchase information that is sent to the WSP from the |
| | customer's mobile communication device when the customer |
| | places an order with the WSP or a MCM, and may include |
| | the P/S_LIST and MCM_ID |
| MCM_ID | The unique identification code that identifies a mobile |
| | commerce merchant to the WSP, FSP, TPC, and to the |
| | customer |
| MO_DATA | All information regarding the customer's order that is |
| | generated by the WSP (e.g., by the WSP mobile commerce |
| | system) based on MP_DATA and other parameters, and |
| | may include (in addition to MP_DATA): CUST_INFO, |
| | CHARGE_$, MO_ID, and PMT_INFO (based on information |
| | already in possession of the WSP) |
| MO_ID | The unique identification code assigned to the order by the |
| | WSP, that identifies the order to the WSP, MCM, FSP, TPC, and to the |
| | customer |
| MO_CONF | Mobile Order Confirmation - a notification provided by the |
| | WSP to the customer if PREL_APP was received by the |
| | WSP from the FSP, and may include MCM_ID, MO_ID, |
| | P/S_LIST, CHARGE_$, and MO_INFO |
| MO_INFO | Any additional order information (estimated shipping time, |
| | etc.) that is provided by the WSP and/or the mobile |
| | commerce merchant to the customer as part of the order |
| | confirmation process |
| AUTH_REQ | Authorization Request - submitted by the WSP to the FSP |
| | along with all necessary information to enable authorization |
| | for the order to be obtained from the customer |
| MP_DEC | Mobile Payment Declined - a notification provided by the |
| | FSP to the WSP (and optionally to the customer) if the funds |
| | to which the customer's financial account has access are |
| | insufficient to cover the CHARGE_$ |
| MT_INFO | Mobile Transaction Information - the information about the |
| | entire order process that may be stored by the WSP, the |
| | mobile commerce merchant, and/or the FSP |
| WOF | Written Order Form - an order form filled out by the |
| | customer and sent to the merchant by mail, via facsimile, or |
| | by electronic mail. |

In the various inventive embodiments of FIGS. 1 to 12, references are made to the terms “customer”, “merchant”, “FSP”, “TPC”, “FTI”, “WSP” in singular form by way of example only for the sake of clarity and convenience. It should be understood to one skilled in the art, that in practice, the system and method of the present invention are readily and advantageously applied to any commercial transactions involving any number of customers, merchants, and other parties, as a matter of necessity or design choice. Thus, as an example, a single merchant can accept orders from thousands of customers utilizing different FSPs (and related parties), while a customer may place different orders with many different merchants utilizing the same FSP or different FSPs.

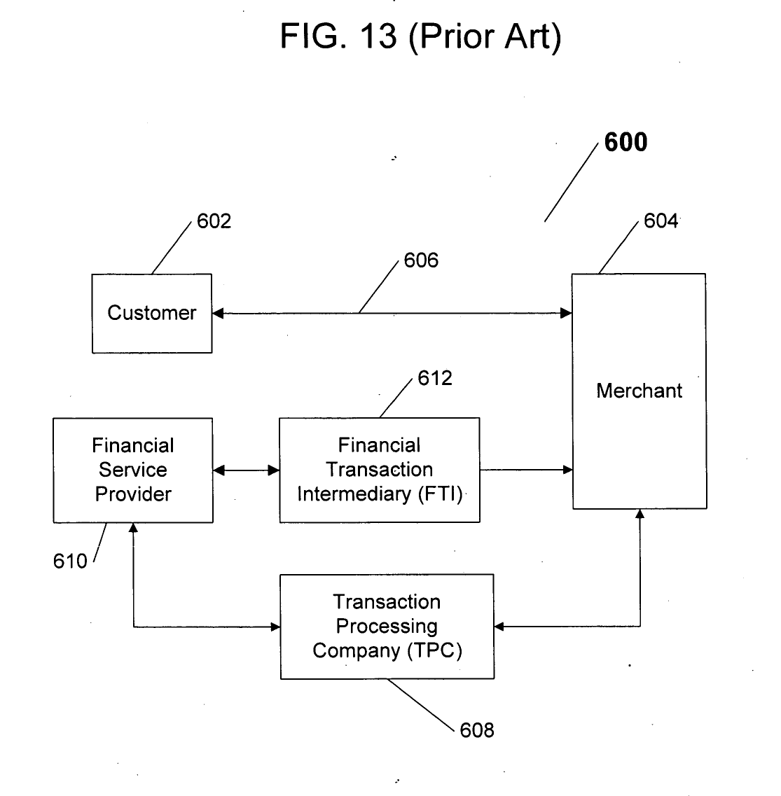

Prior to describing the various embodiments of the present invention, it would also be helpful to provide a brief overview of the current remote order transaction infrastructure, as well as of the corresponding transaction process. Referring now to Prior Art FIG. 13, a previously known commercial order process 600 is shown. A customer 602 places an order with a merchant 604 by communicating the order, along with the customer's CFD to be used for payment, through a communication link 606 (e.g., via the Internet, telephone, facsimile, or mail order). The merchant 604 then submits the order for payment authorization from the customer 602's FSP 610, typically through a transaction processing company 608. Assuming the order contains the correct CFD, the FSP 610 ensures that the customer 602 has sufficient funds in their account to cover the required payment, and then instructs a financial transaction intermediary 612 to transmit the payment to the merchant 604. If the funds in the customer 602 account are insufficient, the FSP 610 declines merchant 604's request for payment, which typically results in the order being cancelled. Advantageously, the various embodiments of the inventive system and method described below in conjunction with FIGS. 1-12 provide complete secure transaction capability by modifying the previously known process 600 with one or more novel configurations, while retaining the basic infrastructure of the system underlying the process 600, resulting in secure remote order transactions with virtually no changes to the current commercial transactions infrastructure.

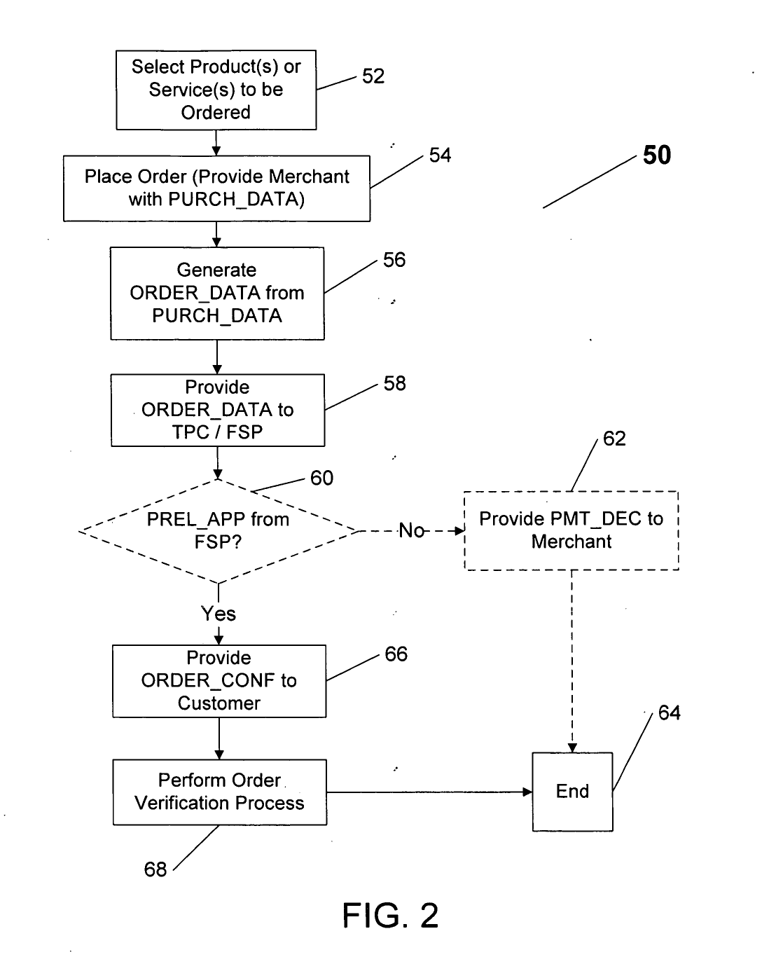

Referring now to FIG. 1, a first exemplary embodiment of the inventive secure order transaction system is shown as a system 10. The various novel embodiments of the operation of the system 10 are described in greater detail below in connection with FIGS. 2-5. The system 10 includes an order component 12, and a financial operations component 30, that interact with one another through communication links 26, 42, and 48, described in greater detail below.

The order component 12 represents the interaction between a customer 14 and a merchant 16, that enables the customer 14 to communicate an order for a product and/or service to the merchant 16, and that enables the merchant 16 to communicate order confirmation and other information to the customer 14. The merchant 16 utilizes a merchant system 20, for offering products and/or services in a manner viewable by the customer 14, that also enables the customer 14 to place an order for the products and/or services offered by the merchant 16, utilizing a customer system 18, through a communication link 22. The merchant system 20 is also preferably capable of communicating with the customer system 18, and with various sub-components of the operations component 30 through the communication links 26, 48 (as described in greater detail below). The merchant system 20 is preferably implemented as a data processing system, such as a computer system, or a network of computer systems, that include(s) all necessary equipment and software to accomplish at least the above-indicated purposes thereof.

The customer 14 utilizes a customer system 18 for interacting with the merchant system 20 to peruse and view the products and/or services offered by the merchant 16 through the merchant system 20, for remotely placing an order for the desired products and/or services from the merchant 16, and optionally for receiving communications from the merchant system 20 through the communication link 22. The customer system 18 may be implemented as a data processing system that include(s) all necessary equipment and software to accomplish at least the above-indicated purposes thereof. Examples of data processing systems that may be readily utilized as the customer system 18, in accordance with the present invention include, but are not limited to:
a computer system:
   mobile computer system—e.g., a notebook computer, a personal digital assistant (PDA), an interactive mobile telephone, etc.;
   stationary computer system—e.g., a personal computer workstation, or
   a network of computer systems (for example including one or more computer servers); or
any other type of interactive device (for example, an interactive entertainment (e.g., cable, satellite, etc.) unit).

The communication link 22, may be any form of a communication link or network (whether wire-based, wireless, or a combination thereof) that enables electronic communication between the customer system 18 and the merchant system 20. The specific implementation of the communication link 22 utilized is preferably selected as a matter of necessity and/or design choice, for example based on the implementations of the customer system 18 and the merchant system 20, without departing from the spirit of the present invention. Thus, for example:
When the customer system 18 is a computer system or a home entertainment system component, and the merchant system 20 is a computer system, the communication link 22 may be the Internet;
When the customer system 18 is an interactive entertainment unit, and the merchant system 20 is the corresponding entertainment service provider computer system, the communication link 22 may be the cable or satellite network; and
When the customer system 18 is an interactive mobile telephone, the customer is subscribed to a wireless service provider, and the merchant system 20 a computer system, the communication link 22 may be the wireless service network of the wireless service provider and all components necessary for the customer system 18 and the merchant system 20 to communicate therewith.

The nature, size, and the composition of the merchant system 20 are preferably selected as a matter of necessity and/or design choice, for example based on the requirements of the merchant 16, the types of products and/or services offered by the merchant 16, the nature of customer systems 18 that will be communicating therewith, and the scale of merchant 16 operation, without departing from the spirit of the present invention. For example:
A small on-line merchant 16 that receives a few dozen of orders per day may utilize a personal computer, in conjunction with powerful equipment of a subscription-based web-hosting service (not shown), as the merchant system 20;
A large on-line retailer merchant 16 may utilize their own network of powerful high-throughput computer systems, capable of hosting and operating an on-line store that handles thousands of orders per day; and
An entertainment service provider merchant 16 (for example, a cable or satellite company in conjunction with one or more partner merchants) may utilize their own network of powerful high-throughput computer systems, capable of interacting with the customer system 18 and, optionally, with the systems of their partner merchant(s) (not shown).

The customer 14 also utilizes a customer communication device 24 (which may be a telephone or an equivalent thereof for communicating with the customer 14's FSP 34 (as described in greater detail below in connection with FIGS. 2 to 5). In an alternate embodiment of the present invention, the customer communication device 24 may be incorporated into the customer system 18 as an integral component thereof. Thus, for example, if the customer system 18 is a mobile interactive telephone that enables the customer 14 to place electronic orders with an on-line merchant, the customer communication device 24 may be the voice communication portion of the mobile telephone.

The financial operations component 30 represents the interaction between a TPC 32, the FSP 34 and a FTI 46, that, in response to communication with the order component 12, results in approval or denial by the FSP 34, of payment to the merchant 16 for an order placed therewith by the customer 14, and when, the payment is approved, results in processing of the payment to the merchant 16. The FSP 34 utilizes an FSP system 38 for receiving, through a communication link 36, order information submitted by the merchant 16 to the TPC 32 through the communication link 26, relating to the order placed by the customer 14 with the merchant 16. The FSP 34 also utilizes a FSP communication system 40, for communicating with the customer communication device 24, through the communication link 42, to verify that the customer 14 indeed placed the order. If the order is verified, the FSP system 38 is also capable of instructing the appropriate FTI 46 through the communication link 44, to issue payment to the merchant 16 through the communication link 48 (for example by transferring the necessary funds to a predetermined financial account of the merchant 16).

Preferably, the FSP communication system 40 is configured based on the nature of the customer communication device 24, and optionally based on the volume of desirable communications with FSP 34 customers. Thus, for example, if the customer communication device 24 is a telephone, the FSP communication system 40 may be a powerful multi-operator telephone system with the capacity of hundreds or thousands of simultaneous telephone connections with various customer communication devices. Similarly, the communication link 42 is preferably selected to enable communication between the FSP communication system 40 and the customer communication device 24. Thus, for example, if the FSP communication system 40 and the customer communication device 24 are both telephone-based, the communication link 42 may be a telephone communication network (and would also include a wireless communication network if the consumer communication device 24 is a mobile telephone).

The various communication links 26, 36, 44, and 48 may be implemented individually as direct communication lines or in any combination of two or more as part of one or more communication networks (e.g., the Internet, wide area networks, virtual private networks, or equivalent thereof. Preferably, the communication link 48 is sufficiently secure to enable safe transmission of payments to the merchant 16.

It should be noted that the TPC 32, the FSP 34, and the FTI 46, are shown in FIG. 1 as individual entities by way of example only. Accordingly, the FSP 34 may incorporate and implement all the functionality and capabilities of one or both of the TPC 32 and the FTI 46.

The various embodiments of the process of operation of the inventive system 10 and the components 12 and 30, are preferably implemented as combinations of steps performed by the customer 14 utilizing the customer system 18, by the merchant 16 utilizing the merchant system 20, and by the TPC 32, the FSP 34, and the FTI 46, that are initiated when the customer 14 places an order with the merchant 16, and that are subject to predetermined rules and/or policies established by the FSP 34 (that may be optionally configured by the customer 14 with the FSP 34 prior approval). It should thus, be noted that some of the steps and functions described below in connection with FIGS. 2, 4, and 5, may be performed by different parties from those described, or by agents of the parties, or may be performed manually or automatically, as a matter of design choice convenience, or necessity, without departing from the spirit of the invention.

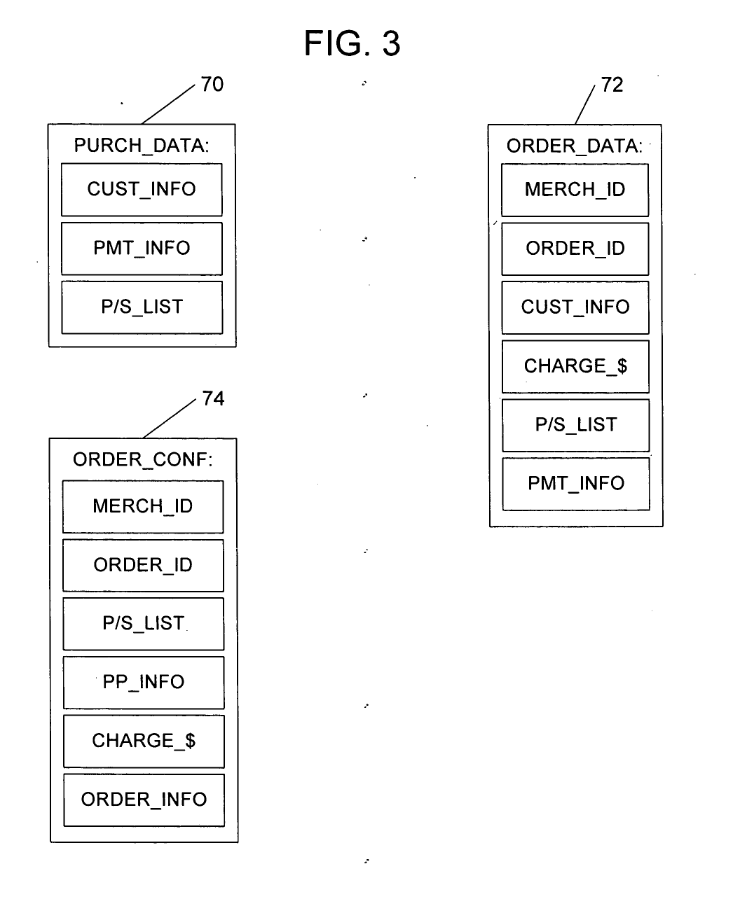

Referring now to FIGS. 2-5 a first exemplary embodiment of the process of operation of the inventive system 10 is shown as a process 50. The process 50 begins at a step 52 when the customer 14 selects a product and/or service offered by the merchant 16, for example utilizing the customer system 18 to communicate with the merchant system 20, through the communication link 22. At a step 54, the customer 14 places the order for the selected product and/or service by causing the customer system 18 to provide the merchant system 20 with PURCH_DATA (shown as PURCH_DATA 70 in FIG. 3, and described in greater detail above in Table 2), which is transmitted to the merchant system 20. Optionally, the PURCH_DATA 70 may be encrypted during transmission to the merchant system 20, using any previously known encryption technique. The PURCH_DATA 70 includes CUST_INFO, PMT_INFO, and P/S_LIST as described above in Table 2. At a step 56, the merchant system 20 generates ORDER_DATA (shown as ORDER_DATA 72 in FIG. 3, and described in greater detail above in Table 2), which may include one or more of the following data items (also described above in Table 2): PURCH_DATA, MERCH_ID, CHARGE_$, PMT_INFO, and ORDER_ID. At a step 58, the merchant 16 submits, via the merchant system 20 or by other means, the ORDER_DATA 72 to the FSP 34 identified in the PMT_INFO (typically by first transmitting the ORDER_DATA 72 to the TPC 32, which then forwards it to the FSP 34 after processing).

After receiving the ORDER_DATA 72, at an optional step 60, the FSP 34 determines if PREL_APP should be issued to the merchant 16, based on whether the customer 14's payment instrument identified in the PMT_INFO has access to sufficient funds through the customer 14 financial account with the FSP 34, to make a payment to the merchant 16 in the amount of the CHARGE_$. If a PREL_APP is not issued, then, at an optional step 62, the FSP 34 provides a PMT_DEC notice to the merchant 16 (which can then be communicated to the customer 14 in accordance with the merchant 16's business policies (e.g., before, or after, cancellation of the order placed by the customer 14 at the step 54)), and the process 50 then ends at a step 64. Otherwise, when a PREL_APP is issued, then the process 50 proceeds to a step 66 where the merchant 16 provides the customer 14 with ORDER_CONF (shown as ORDER_CONF 74 in FIG. 3, and described in greater detail in Table 2 above).

At a step 68, an order verification process is performed (through interaction between the customer 14 and the FSP 34) to ensure that the order placed at the step 54, was in fact placed by the authorized holder of the financial account to which the payment instrument identified by the PMT_INFO is linked. The order verification process is key novel feature of the present invention, which may be performed in a variety of ways, but in essence involves predefined contact between the customer 14 and the FSP 34 (for example by the customer 14 contacting an authorized FSP 34 representative or vice versa) during which the customer 14's identity is verified by the FSP 34, and during which at least a portion of the ORDER_CONF 74 is provided by the customer 14 to the FSP 34 and compared to the ORDER_DATA 12 received by the FSP 34 from the merchant 16, to verify and authorize the order placed at the step 54. If the order is verified, then the FSP 34 authorizes the appropriate payment to the merchant 16. The process 50 then ends at the step 64. All order-transaction events occurring after that time (e.g., order fulfillment by the merchant 16, etc.) occur in the same manner as do current conventional post-order transactions.

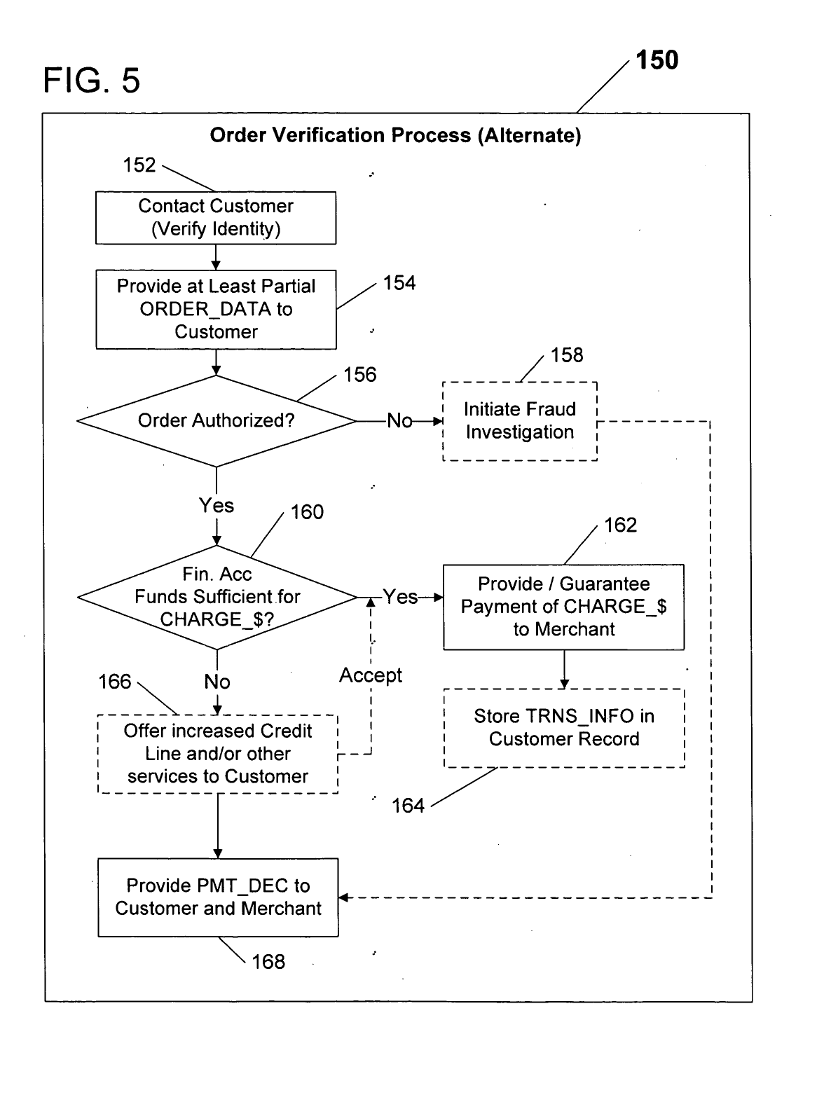

Referring now to FIGS. 4 and 5, two exemplary embodiments of an order verification process that takes place at the step 68 of FIG. 2, are shown as an order verification process 100 (in which the customer 14 contacts the FSP 34 to verify the order), and an alternate order verification process 150 (in which the FSP 34 contacts the customer 14 to verify the order), respectively. Preferably, the exact manner in which the processes 100 and 150 are performed, and all necessary implementation details (such as day and time availability of the customer 14 and the FSP 34, the customer 14 and FSP 34 contact information, etc.) are pre-arranged between the customer 14 and the FSP 34 in a manner convenient and acceptable to both parties. These arrangements may be simply dictated by the FSP 34 and then accepted by the customer 14, or optionally, the customer 14 may be involved in configuring the arrangements in accordance with their preferences.

Referring first to FIG. 4, the order verification process 100, begins at a step 102, when the customer 14 uses the customer communication device 24 to contact the FSP 34 through the FSP communication system 40, and verifies their identity to the FSP 34, for example by providing a password or other form of security code or secret information in response to a request from the FSP 34. At a step 104, the customer 14 provides information representative of at least a portion of the ORDER_CONF 74 to the FSP 34, and, when the FSP 34 confirms that the information matches the ORDER_DATA 72 received by the FSP 34 from the merchant 16, the customer 14 provides verification for the order at a step 108.

At a step 110, which can optionally be performed previously at any time after step 102, the FSP 34 then determines if the financial account of the customer 14, identified by PMT_INFO, has access to sufficient funds to cover payment to the merchant 16 in the amount of CHARGE_$. If the funds are not sufficient, at a step 114, the FSP 34 declines the payment by issuing the PMT_DEC notice to the customer 14 and to the merchant 16 and then returns to the process 50.

One of the advantages of the present invention, is that the FSP 34 is placed into direct contact with the customer 14, thus, during the interaction between the customer 14 and the FSP 34 throughout the process 100, the FSP 34 is able to offer various services to the customer 14, that are related or unrelated to the order being verified (e.g., an purchase protection plan, an additional credit card, etc.), in accordance with the FSP 34 direct marketing policies. Optionally, instead of proceeding directly to the step 114, if the funds are determined to be insufficient at the step 110, at an optional step 112, the FSP 34 can offer one or more services to the customer 14 that are specifically relevant to the fact that the order transaction being verified may be imminently declined by the FSP 34. Services offered by the FSP 34 at the optional step 112, may include one or more of the following: an increase of the customer 14's payment instrument credit line so that the funds are sufficient to cover the CHARGE_$, a loan, or a predefined period that the FSP 34 will wait for the customer 14 to increase available funds before performing the step 110 again. Of course if the customer 14 refuses the offered service(s), the process 100 continues to the step 114. The optional step 112, thus provides the FSP 34 with unprecedented customer service and marketing tools that are optimally applied when the customer 14 is in actual need thereof.

If the result of the step 110 is positive, then at a step 116, the FSP 34 provides or guarantees the payment of CHARGE_$ to the merchant 16, and at an optional step 118, stores the TRNS_INFO (described above in Table 2) in a customer 14 record (not shown), before returning to the process 50.

Referring now to FIG. 5, the order verification process 150, begins at a step 152, when the FSP 34 uses the FSP communication system 40 to contact the customer 14 through the customer communication device 24, and verifies the customer 14 identity, for example by asking the customer 14 to provide a password or other form of security code or secret information in response to a predetermined request from the FSP 34. At a step 154, the FSP 34 provides information representative of at least a portion of the ORDER_DATA 72 received by the FSP 34 from the merchant 16 to the customer 14, and then proceeds to a step 156.

At the step 156, the customer 14 either confirms that they actually placed the order identified at the step 154, in which case the process continues to a step 160, or denies that they placed the identified order, in which case, at an optional step 158, the FSP 34 initiates a fraud investigation of the unauthorized order, and then proceeds to a step 168, where the PMT_DEC notice is provided to the merchant 16 (and of course to the customer 14). The process 150 then performs the steps 160 through 168 in substantially identical manner to how the process 100 (of FIG. 4) performs the corresponding steps 110 to 118, that are described above in connection with FIG. 4.

Advantageously, the inventive system 10 may be readily utilized to enable the customer 14 to engage in secure remote order transactions with the merchant 16 without placing their CFD at any risk of misappropriation. In fact, because the PMT_INFO requires only a portion of the CFD, the customer 14 does not even need to store their CFD on their customer system 18, further reducing the likelihood of CFD theft.

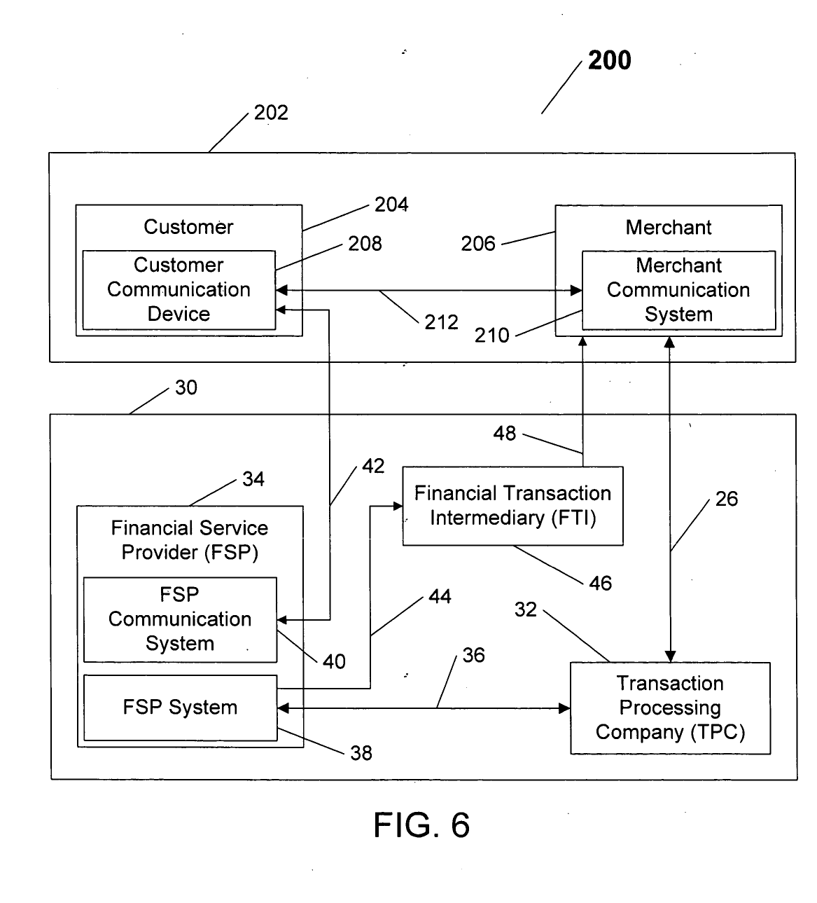

As previously discussed, the system and method of the present invention are equally applicable to all forms of remote purchase transactions that do not take place on-line. Various embodiments of the inventive system and method advantageously configured for different types of remote order transactions are shown and described below in connection with FIGS. 6-12. It should be noted that in each of the embodiments of the present invention shown in FIGS. 6, 7 and 11, the financial operations component 30 is the same as the financial operations component 30 of FIG. 1. This clearly demonstrates, yet again, that the various embodiments of the present invention can operate equally well with the currently existing commercial order transaction infrastructure.

Referring now to FIG. 6, a second exemplary embodiment of the inventive secure order transaction system, suitable for remote telephone order transactions, is shown as a system 200. The system 200 includes an order component 202 and a financial operations component 30 (of FIG. 1) that interact with one another through communication links 26, 42, and 48, as described in greater detail below.

The order component 202 represents the interaction between a customer 204 and a merchant 206, that enables the customer 204 to communicate an order for a product and/or service to the merchant 206, and that enables the merchant 206 to communicate order confirmation and other information to the customer 204. The merchant 206 can utilize one or more approaches for communicating offered products and/or services to the customer 204, such as by advertising/marketing (e.g., via radio, print, television, promotional, live, direct mail, email, or telemarketing) and/or by providing a manner in which the customer 204 can seek out and peruse the products and/or services offered by the merchant 206, such as via a print catalog, a retail store, an on-line store, or through any combination thereof.

The customer 204 preferably utilizes a customer communication device 208, which may be a telephone or equivalent form of voice communication device (for example corresponding to the customer communication device 24 of FIG. 1), to communicate an order for a product and/or service to the merchant 206, via a communication link 212 connected to a merchant communication system 210. The customer communication device 208 may likewise be used for communication with the FSP communication system 40 when necessary.

The merchant communication system 210 may range from a single telephone connected to a telephone line which in turn connects to the communication link 212, to a multi-line multi-operator telephone system capable of handling hundreds or thousands of simultaneous voice communications with customer communication devices. Similarly, the communication link 212 may be a telephone communication network, or a combination of a telephone communication network and a wireless network, if the customer communication device 208 is wireless.

Other than the way in which the customer 204 communicates the order (i.e., PURCH_DATA) to the merchant 206, the system 200 operates in a substantially similar manner to the system 10 of FIG. 1. Thus, the process 50 of FIG. 2, as well as data items 70-74 of FIG. 3, and the order verification processes 100 and 150, of FIGS. 4 and 5, respectively, are all equally applicable to, and useable by the system 200.

Of course, it should be understood to one skilled in the art, that the merchant 206 may utilize one or more additional systems (not shown), such as a merchant computer system (e.g., the merchant system 20 of FIG. 1), to enter the PURCH_DATA received from the customer 204 into an electronic format, and then to automatically generate the ORDER_DATA which may be sent to the financial operations component 30, and ORDER_CONF (which may be sent to the customer 204 by other means such as electronic mail, postal mail, facsimile, or via an equivalent thereof).

The proliferation of increasingly powerful and feature-rich mobile communication devices in the last few years, along with a simultaneous decline in device and wireless service costs, enabled mobile commerce to experience nearly exponential growth. Certainly, a customer is able to engage in mobile commerce by utilizing a sophisticated interactive mobile communication device (e.g., as the customer system 18 of FIG: 1), and thus taking advantage of the features of the inventive system 10, while a customer utilizing a conventional non-interactive mobile communication device (e.g., as the customer communication device 208 of FIG. 6), can take advantage of the features of the inventive system 200.

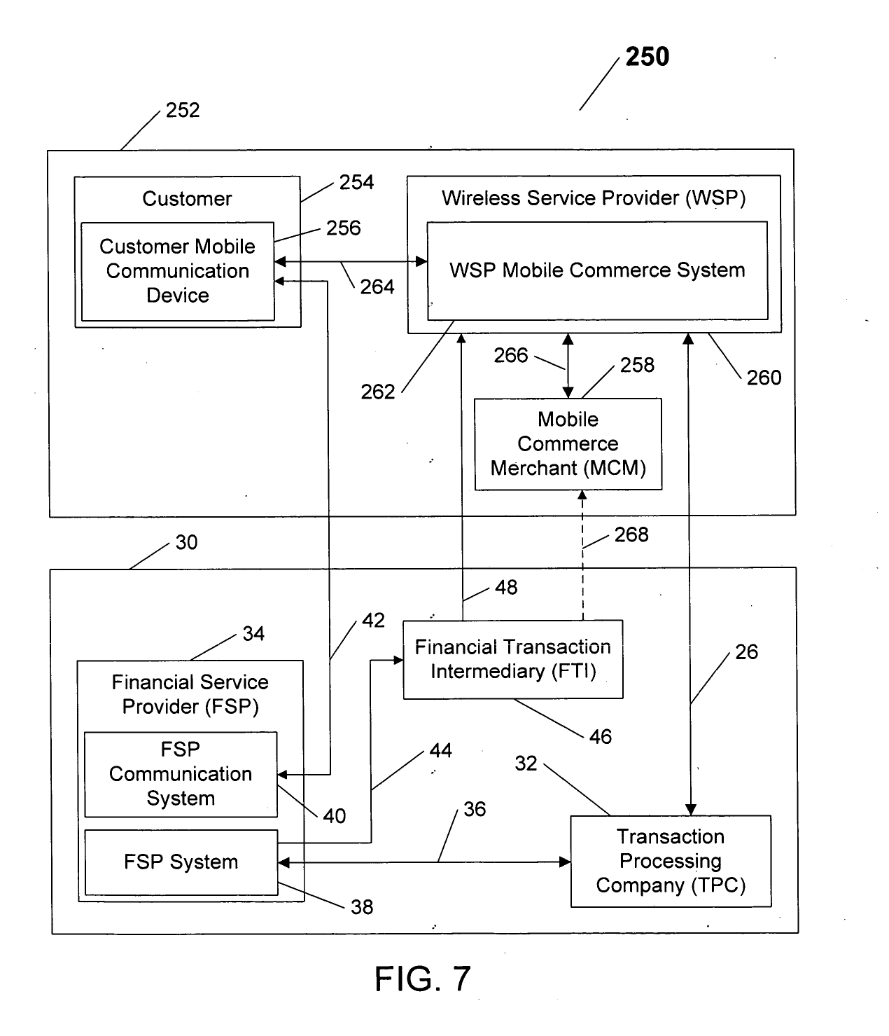

However, to pursue certain opportunities uniquely offered by mobile commerce, referring now to FIGS. 7-10, a third exemplary embodiment of the inventive secure order transaction system, suitable for remote mobile commerce order transactions, is shown as a system 250 of FIG. 7. Examples of unique mobile commerce opportunities include, but are not limited to, the following: enhancements to, or additional features for, a customer mobile communication device, additional wireless service provider (WSP) services, various premium mobile services (for example, short message service (SMS) or multimedia message service (MMS) based services for ordering entertainment and/or travel tickets, event notifications, weather notices, news, etc.), and/or products from specific mobile commerce merchants (MCM) that have partnered with the WSP.

The system 250 includes a mobile order component 252, and a financial operations component 30 (of FIG. 1), that interact with one another through communication links 26, 42, 48, and optionally link 268, as described in greater detail below. In essence, the system 250 operates in a similar manner to the system 10 of FIG. 1, in that a customer mobile communication device 256 incorporates the functionality of both the customer system 18 and the customer communication device 24, and in that a communication link 264 is equivalent to a wireless embodiment of the communication link 22 of FIG. 1, with the following key differences:
In the system 250, a WSP (see Table 2, above) 260 may serve as both a merchant providing their own products and/or services, or serve as an intermediary between the customer 254 and a MCM (see Table 2 above) 258, that offer products and/or services to the customer 254 through the WSP 260; and
The WSP 260 is supplied with the PMT_INFO (see Table 2) of the customer 254 as part of the subscription process, and therefore there is no need to transmit the PMT_INFO, from the customer 254 and the WSP 260, when a mobile order is placed. However, because the customer mobile communication device 256 may be lost or stolen, it is still necessary to verify placement of a mobile order by the customer 254.

The order component 252, enables the customer 254 to place an order for a product and/or service, through interaction between the customer 254, and the WSP 260, and optionally between the customer 254 and the MCM 258, with the WSP 260 acting as an intermediary. During operation of the system 250, the WSP 260 (and/or the MCM 258) utilizes the WSP mobile commerce system 262 to offer products and/or services in a manner viewable by the customer 254 (either sought out by the customer 254, or offered to the customer 254 by the WSP 260 via SMS, MMS, or equivalent thereof).

The customer 254 then utilizes the customer mobile communication device 256 to communicate an order for a product and/or service to the WSP 260, or to the MCM 258 (which communicates with the customer 254 through the communication link 266 and then through the WSP 260). The WSP 260 then utilizes a WSP mobile commerce system 262 to communicate order confirmation and other information from the WSP 260, and/or the MCM 258, to the customer 254, and then communicates with various sub-components of the financial operations component 30, through the communication links 26, 48 (in a manner similar to the merchant system 20 of FIG. 1). Optionally, if the customer 254 placed the order with the MCM 258, and depending on prior business arrangements between the WSP 260 and the MCM 258, instead of utilizing the communication link 48, the MCM 258, may communicate with the operations component 30 via the optional communication link 268, bypassing the WSP 260.

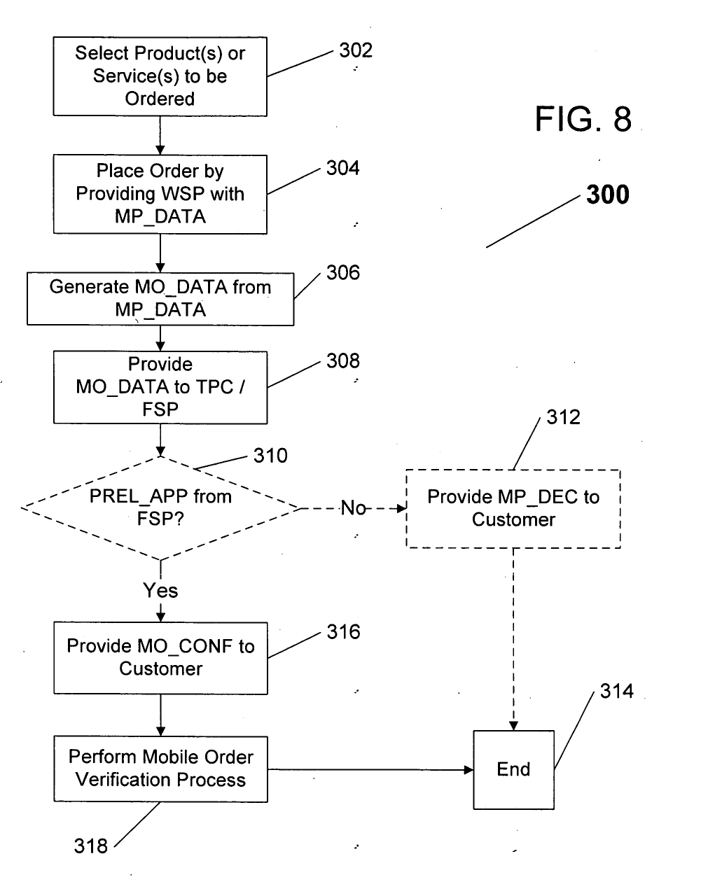

The WSP mobile commerce system 262 is preferably implemented as a data processing system, such as a computer system, or a network of computer systems, that includes all necessary equipment to send and receive wireless communications via the communication link 264, and preferably include(s) all necessary equipment and software to accomplish at least the above-indicated purposes thereof. The customer 254 also utilizes the customer mobile communication device 256 for communicating with the customer 254's FSP 34 via the communication link 34 (as described in greater detail below in connection with FIGS. 8 to 10).

As previously noted, the operation of the system 250 occurs in a similar manner to the system 10 of FIG. 1, nevertheless to highlight the above-described differences between the system 250 and the system 10, referring now to FIG. 8, an exemplary embodiment of a process of operation of the system 250 is shown as a process 300.

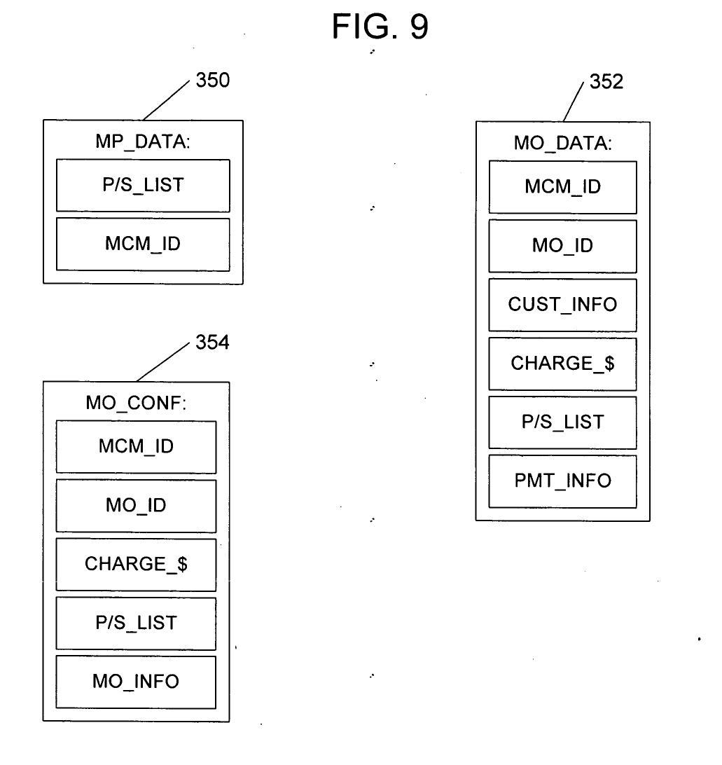

The process 300 begins at a step 302 when the customer 254 selects a product and/or service offered by the WSP 260 (and/or the MCM 258), for example utilizing customer mobile communication device 256 to communicate with the WSP 260 (and, optionally, the MCM 258) through the communication link 264. At a step 304, the customer 254 places the order for the selected product and/or service by causing the customer mobile communication device 256 to provide the WSP mobile commerce system 262 with MP_DATA (shown as MP_DATA 350 in FIG. 9, and described in greater detail above in Table 2), by transmitting the MP_DATA 350 thereto along with a standard identification code (not shown), that identifies the specific customer mobile communication device 256 (and in most cases the customer 254) to the WSP 260, and that is linked to the CUST_INFO (see Table 2) of the customer 254.

The MP_DATA 350 includes the P/S_LIST, and, if the order is being placed with the MCM 258, also includes their MCM_ID, as described above in Table 2. At a step 306, WSP mobile commerce system 262 generates MO_DATA (shown as MO_DATA 352 in FIG. 9, and described in greater detail above in Table 2), which may include one or more of the following data items, also described above in Table 2: MP_DATA, CUST_INFO (already in possession of WSP 260), CHARGE_$, and MO_ID. At a step 308, the WSP 260 submits, via the WSP mobile commerce system 262, or by other means, the MO_DATA 352, to the FSP 34 identified in the PMT_INFO (typically by first transmitting the MO_DATA 352 to the TPC 32 which then forwards it to the FSP 34 after processing).

After receiving the MO_DATA 352, at an optional step 310, the FSP 34 determines if PREL_APP should be issued to the WSP 260 (or to the MCM 258), based on whether the customer 254's payment instrument identified in the PMT_INFO has access to sufficient funds in the customer 254 financial account with the FSP 34, to make a payment to the WSP 260 (or to the MCM 258) in the amount of the CHARGE_$.

If a PREL_APP is not issued, at an optional step 312, the FSP 34 provides a MP_DEC notice (see Table 2) to the WSP 260 (or to the MCM 258), which can then be communicated to the customer 254 in accordance with the business policies of the WSP 260 (or of the MCM 258)—e.g., before or after cancellation of the order placed by the customer 254 at the step 304, and the process 300 then ends at a step 314. Otherwise, when a PREL_APP is issued, the process 300 proceeds to a step 316 where the WSP 260 (or of the MCM 258) provides the customer 254 with MO_CONF (shown as MO_CONF 354 in FIG. 9, and described in greater detail in Table 2 above).

At a step 318, a mobile order verification process is performed (through interaction between the customer 254 and the FSP 34) to ensure that the order placed at the step 304 was in fact placed by the authorized holder of the financial account to which the payment instrument identified by the PMT_INFO is linked. The mobile order verification process may be performed in a variety of ways, but for example, may involve a predefined contact between the customer 254 and the FSP 34 (for example by the customer 254 contacting an authorized FSP 34 representative or vice versa) during which at the customer 254's identity is verified by the FSP 34, and during which at least a portion of the MO_CONF 354 is provided by the customer 254 to the FSP 34 and compared to the MO_DATA 352 received by the FSP 34 from the WSP 260 (or from the MCM 258), to authorize and verify the order placed at the step 304. If the order is verified, then the FSP 34 authorizes the appropriate payment, to the WSP 260 (or to the MCM 258). The process 300 then ends at the step 314. All order-transaction events occurring after that time (e.g., order fulfillment by the WSP 260 (or to the MCM 258), etc., occur in the same manner as do current conventional post-order mobile commercial transactions.

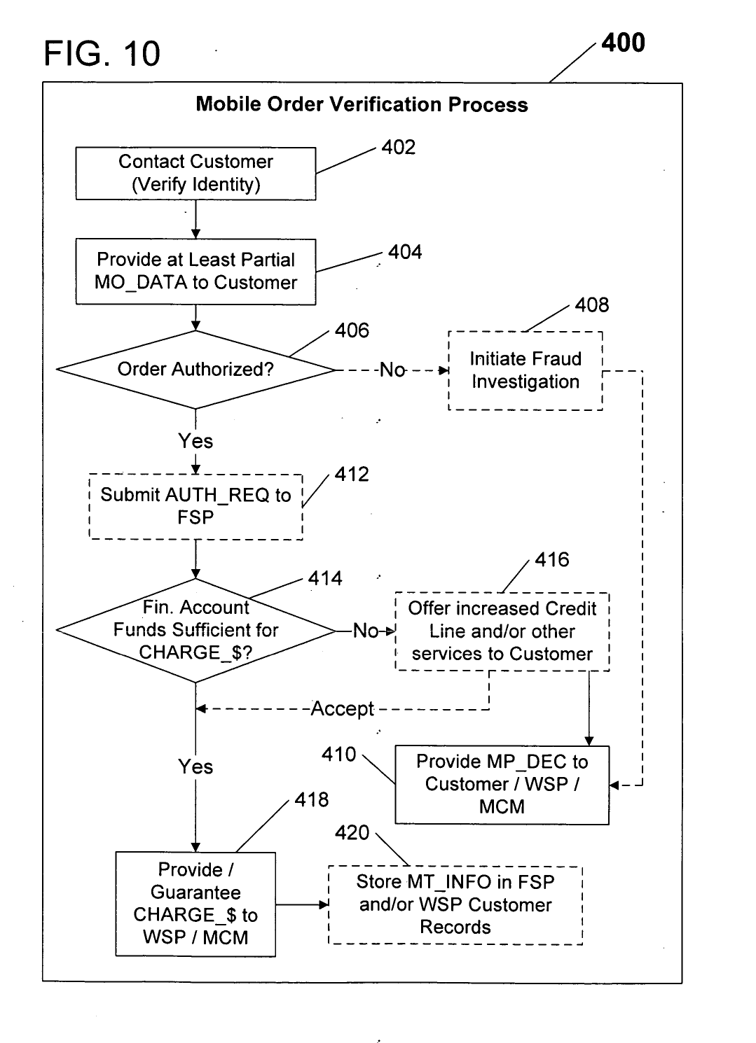

The mobile order verification process performed at the step 318 may be substantially similar to either one of the order verification processes 100 or 150, of FIGS. 4 and 5, respectively. Referring now to FIG. 10, optionally, an alternate embodiment of the order verification process 150 of FIG. 5, shown as a mobile order verification process 400 of FIG. 10, may be advantageously utilized at the step 318. Preferably, the exact manner in which the process 400 is performed, and all necessary implementation details (such as day and time availability of the customer 254 and the FSP 34, which steps are performed by the WSP 260, and which steps are performed by the FSP 34, the preferred contact information of the customer 254, the FSP 34, and/or of the WSP 260, etc.), are pre-arranged between the customer 254 and the FSP 34 (and, optionally, also between the customer 254 and/or the FSP 34 and the WSP 260) in a manner convenient and acceptable to all parties. These arrangements may be simply dictated by the FSP 34 (and/or the WSP 260) and then accepted by the customer 254, or optionally, the customer 254 may be involved in configuring the arrangements to their preferences.

One of the key arrangements of the process 400, involves a decision whether the steps 402 to 410 are performed by the WSP 260 or by the FSP 34. When these steps are performed by the FSP 34, the process 400 operates very similarly to the process 150 of FIG. 5. However, when the WSP 260 performs the steps 402 to 410, in essence the initial order verification is actually performed by the WSP 260 and not by the FSP 34 (which only enters the process later to ensure that sufficient funds are available for payment, and that the payment is made to the WSP 260 (or to the MCM 258). This approach enables the WSP 260 and the FSP 34 to share the performance of the mobile order verification process 250 while remaining consistent to the essence of the present invention—that the CFD always remains with previously authorized secure parties (because WSP 260 is previously supplied with the customer 254 CDF).

The order verification process 400, begins at a step 402, when the WSP 260 (or the FSP 34 using the FSP communication system 40) contacts the customer 254 in a pre-arranged manner—for example via the customer mobile communication device 256, or by other means (e.g., a land-line telephone, etc.), and verifies the identity of the customer 254, for example by asking the customer 254 to provide a password, or other form of security code or secret information, in response to a predetermined request from the WSP 260 (or from the FSP 34). At a step 404, the WSP 260 (or the FSP 34, if the WSP 260 previously transmitted it to the FSP 34), provides information representative of at least a portion of the MO_DATA 352, generated by the WSP 260 (and/or the MCM 258) to the customer 254, and then proceeds to a step 406.

At the step 406, the customer 254 either confirms that they actually placed the order identified at the step 404, in which case the process continues to an optional step 412, or denies that they placed the identified order, in which case, at an optional step 408, the WSP 260 (or the FSP 34) initiates a fraud investigation of the unauthorized order, and then, if the steps 402 to 408 are being performed by the FSP 34, the process 400 proceeds to a step 410, where a MP_DEC (see Table 2) notice is provided to the WSP 260 (and/or the MCM 258), and to the customer 254.

If the steps 402 to 408 are being performed by the WSP 260, then the optional step 412 is performed by the process 400, where the WSP 260 submits an AUTH_REQ (see Table 2) to the FSP 34. The process 400 then proceeds to a step 414, which can optionally be performed by the FSP 34 previously at any time after step 402 (assuming that the steps 402 to 410 are being performed by the FSP 34). At the step 414, the FSP 34 determines if the financial account of the customer 254, identified by PMT_INFO, has access to sufficient funds to cover payment to the WSP 260 (or to the MCM 258) in the amount of CHARGE_$. If the funds are not sufficient, then the FSP 34 proceeds to the previously described step 410, where the payment for the order is declined, and then returns to the process 250. If the funds are sufficient, then the process 400 proceeds to a step 418.

As noted before, one of the advantages of the present invention, is that the FSP 34 is placed into direct contact with the customer 254. Thus, during the interaction between the customer 254 and the FSP 34 throughout the process 400, the FSP 34 is able to offer various services to the customer 254, that are related or unrelated to the order being verified (e.g., an purchase protection plan, an additional credit card, etc.), in accordance with the FSP 34 direct marketing policies. Similarly, if the steps 402 to 408 are performed by the WSP 260, the WSP 260 is given a similar attractive opportunity for direct one-to-one marketing contact with the customer 254.

Optionally, instead of proceeding directly to the step 410, if the funds are determined to be insufficient at the step 414, at an optional step 416, the FSP 34 can offer one or more services to the customer 254 that are specifically relevant to the fact that the order transaction being verified may be imminently declined by the FSP 34. Services offered by the FSP 34 at the optional step 416, may include one or more of the following: an increase of the customer 254's payment instrument credit line so that the funds are sufficient to cover the CHARGE_$, a loan, or a predefined period that the FSP 34 will wait for the customer 254 to increase available funds before performing the step 414 again. Of course if the customer 254 refuses the offered service(s), the process 400 continues to the step 410. The optional step 416, thus provides the FSP 34 (or the WSP 260) with unprecedented customer service and marketing tools that are optimally applied when the customer 254 is in actual need thereof.

At the step 418, the FSP 34 provides or guarantees the payment of CHARGE_$ to the WSP 260 (or to the MCM 258 indirectly via the WSP 260, or directly via the communication link 268), and, at an optional step 420, stores the MT_INFO (described above in Table 2) in a customer 254 record (not shown) by the FSP 34 (and or by the WSP 260), before returning to the process 250.

Advantageously, the inventive system 250 may be readily utilized to enable the customer 254 to engage in mobile commerce through secure remote mobile order transactions with the WSP 260, or with any MCM 258 partnering with the WSP 260, without placing their CFD at any risk of misappropriation.

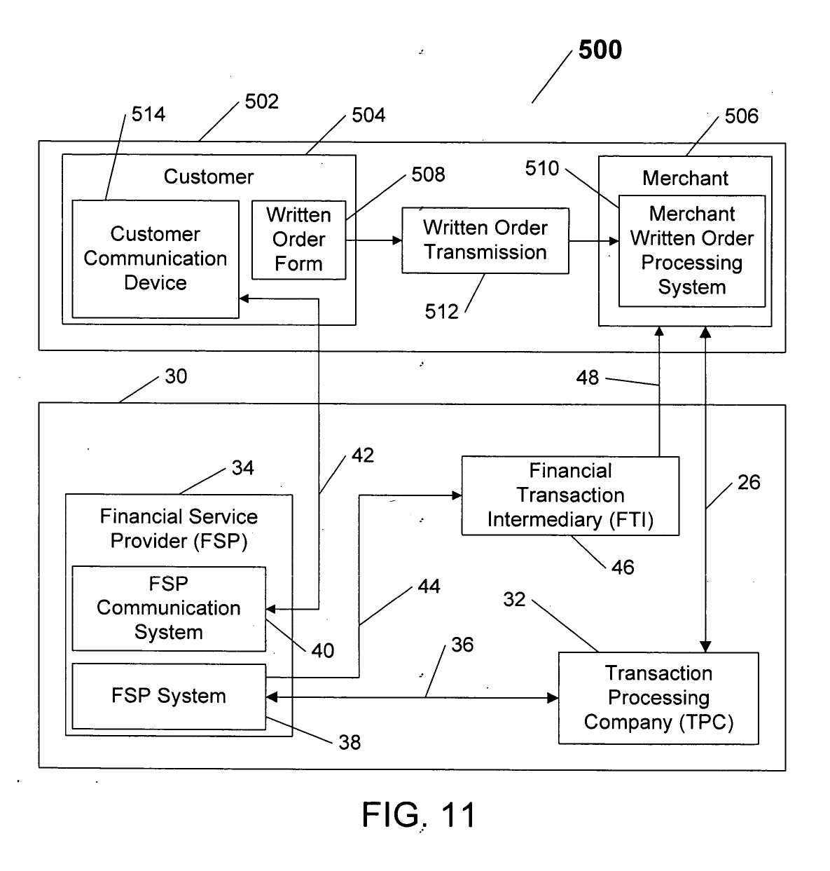

Referring now to FIG. 11, a fourth exemplary embodiment of the inventive secure order transaction system, suitable for remote postal and electronic mail, facsimile, and equivalent order transactions, is shown as a system 500. The system 500 includes an order component 502, and a financial operations component 30 (of FIG. 1) that interact with one another through communication links 26, 42, and 48, as described in greater detail below.

The order component 502 represents the interaction between a customer 504 and a merchant 506, that enables the customer 504 to communicate an order for a product and/or service to the merchant 506, and that also enables the merchant 506 to communicate order confirmation and other information to the customer 504. The merchant 506 can utilize one or more approaches for communicating offered products and/or services to the customer 504, such as by advertising/marketing (e.g., via radio, print, television, promotional, live, direct mail, email, or telemarketing) and/or by providing a manner in which the customer 504 can seek out and peruse the products and/or services offered by the merchant 506, such as via a print catalog, a retail store, an on-line store, or through any combination thereof.

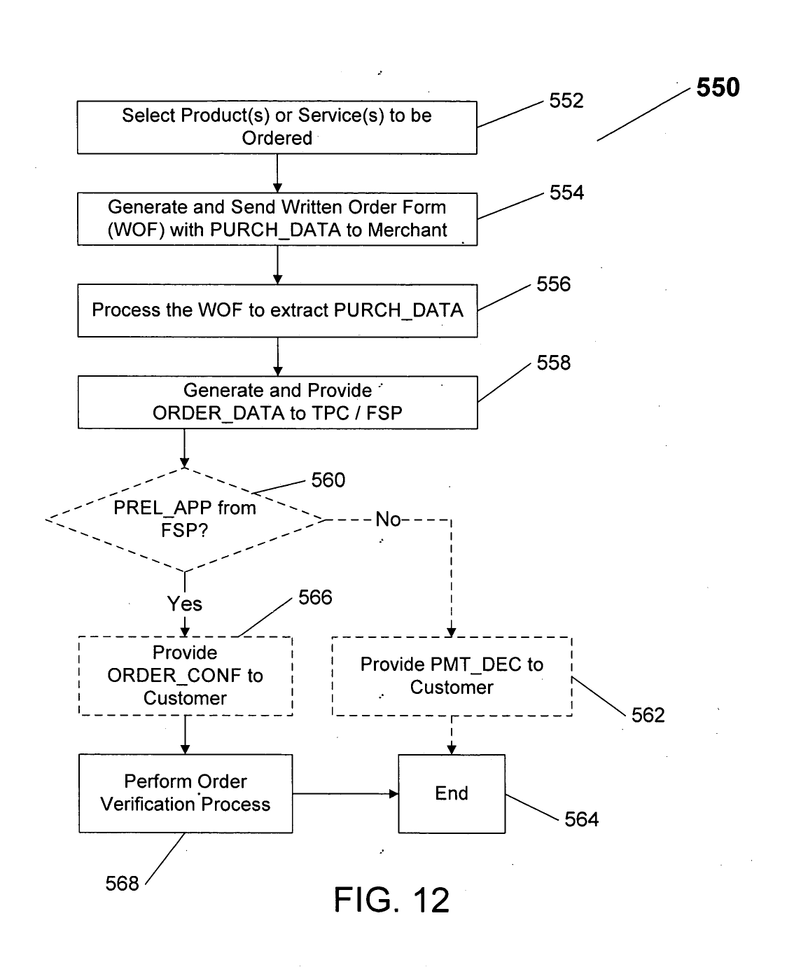

The customer 504 preferably places a desired order with the merchant 506 by first generating a written order form 508, representative of PURCH_DATA (e.g., such as PURCH_DATA 70 of FIG. 3), and then transmitting the written order form 508 to the merchant 506 via a written order transmission method 512. The customer 504 may generate and print the written order form 508 automatically, using a computer system (not shown), such as the customer system 18 (of FIG. 1), or manually, by filling the form out (when the written order form 508 is a customer-printed form, or when the written order form 508 is a pre-printed order form provided by the merchant 506 (for example, as part of an advertising/marketing effort (e.g., as part of a catalog, a published promotional offer, a direct mail offer, or an equivalent thereof))). The customer 504 also preferably is capable of utilizing a customer communication device 514 (such as a telephone or equivalent), to communicate with the FSP 34 during order verification (as described below in connection with FIG. 12).

The written order transmission method 512 may involve utilization of a postal mail service or equivalent (e.g., courier), in which case the written order form 508 is received by the merchant 506 after a period of time, commensurate with the geographic distance of the merchant 506 from the customer 504, and with the type of transmission method 512 used (e.g., postal mail or courier service). Alternately, the written order transmission method 512 may be a facsimile transmission, in which case the customer 504 transmits the written order 508 to the merchant 506 by using a facsimile device (or equivalent—e.g., a computer equipped with facsimile hardware and/or software) (not shown) through a communication network, and the merchant 506 utilizes a facsimile device or equivalent (which may be optionally incorporated into a merchant written order processing system 510) linked to a communication network, to receive the transmitted written order form 508. In an alternate embodiment of the present invention, the written order form 508 is in electronic mail format, in which case the written order transmission method 512 may involve transmission of an electronic mail message containing (or representative) of the written order from 508, through the Internet or through another communication network.

The merchant 506 may utilize the merchant written order processing system 510 to process one or more various types of the written order form 508, to extract the PURCH_DATA therefrom so that ORDER_DATA (e.g., ORDER_DATA 72 of FIG. 3), and, optionally ORDER_CONF (e.g., ORDER_CONF 74 of FIG. 3), may be generated. Thus, the merchant written order processing system 510 may include one or more computer systems (not shown) with manual and/or automatic data entry capabilities to optimize extraction of PURCH_DATA from a received written order form 508, and/or one or more facsimile devices (not shown) for receiving written order forms by facsimile, and/or an electronic mail communication system for receiving written order forms by electronic mail.

The system 500 operates in a substantially similar manner to the system 10 of FIG. 1 with two key differences: (1) the way in which the customer 504 communicates the PURCH_DATA for the order to the merchant 506 (i.e., via a written order form 508 sent by the written order transmission method 512); and (2) the requirement that the merchant 506 extract the PURCH_DATA from the written order form 508 in order to generate the ORDER_DATA, and, optionally ORDER_CONF. In addition, unless prior arrangements have been made, instead of automatically electronically transmitting ORDER_CONF to the customer 504, the merchant 506 may need to do so in another manner, such as via the same written or different order transmission method 512 that was used to send the written order form 508, or by communicating with the customer 504 through the customer communication device 514. Of course, through prior arrangements between the customer 504 and the merchant 506, ORDER_CONF may be sent by any other means, such as via electronic mail, and/or an SMS, MMS, or other message to the customer 504's mobile communication device (not shown), assuming that the customer 504 previously provided the merchant 506 with their corresponding electronic mail address and/or mobile communication device contact number (for example, by including such information on the written order form 508 sent to the merchant 506).

While the process 50 of FIG. 2, as well as data items 70-74 of FIG. 3 are generally applicable to the system 500, for the sake of clarity, referring now to FIGS. 12 and FIG. 3, an exemplary embodiment of the process of operation of the system 500, is shown as a process 550. The process 550 begins at a step 552, when the customer 504 selects a product and/or service offered by the merchant 506. At a step 554, the customer 504 places the order for the selected product and/or service by generating and sending the written order form 508, containing PURCH_DATA 70 for the order, to the merchant 506 utilizing the written order transmission method 512. At a step 556, the merchant 506 receives the written order form 508, and utilizes the merchant written order processing system 510 to process the written order form 508 to extract the PURCH_DATA 70 therefrom. At a step 558, the merchant 506 then generates the ORDER_DATA 72 from the PURCH_DATA 70 and transmits the ORDER_DATA 72 to the FSP 34 (via the TPC 32, or directly).

After receiving the ORDER_DATA 72, at an optional step 560, the FSP 34 determines if PREL_APP should be issued to the merchant 506, based on whether the customer 504's payment instrument identified in the PMT_INFO portion of the ORDER_DATA 72, has access to sufficient funds through the customer 504 financial account with the FSP 34, to make a payment to the merchant 506 in the amount of the CHARGE_$. If a PREL_APP is not issued, at an optional step 562, the FSP 34 provides a PMT_DEC notice to the merchant 506 (which can then be communicated to the customer 504 in accordance with the merchant 506's business policies (e.g., before or after cancellation of the order placed by the customer 504 at the step 554), and the process 550 then ends at a step 564. Otherwise, when a PREL_APP is issued, the process 550 proceeds to an optional step 566, where the merchant 506 provides the customer 504 with ORDER_CONF by the written order transmission method 512 or through other means. The step 566 is optional, because the customer is likely to retain a copy of the written order form 508 which can serve the same purpose as ORDER_CONF during an order verification process.

At a step 568, an order verification process is performed (through interaction between the customer 504 and the FSP 34) to ensure that the order placed at the step 554 was in fact placed by the authorized holder of the financial account to which the payment instrument identified by the PMT_INFO is linked. The order verification process of step 568 may be either one of the advantageous order verification processes 100, and 150, shown in FIG. 4 and FIG. 5, respectively. If the order is verified at the step 568, then the FSP 34 authorizes the appropriate payment to the merchant 506. The process 550 then ends at the step 564. All order-transaction events occurring after that time (e.g., order fulfillment by the merchant 506, etc.) occur in the same manner as do current conventional post-order transactions.

In conclusion, as previously discussed, several embodiments of novel secure remote order transaction systems, and accompanying processes, are shown and described which enable much more secure commercial transactions than possible with previously known methods, at a minimal expense to the customers and merchants, and that also enable FSPs to offer additional products and/or services to customers at very opportune times.

Thus, while there have been shown and described and pointed out fundamental novel features of the invention, as applied to preferred embodiments thereof, it will be understood that various omissions and substitutions and changes in the form and details of the devices and methods illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. It is the intention, therefore, to be limited only as indicated by the scope of the claims appended hereto.

We claim:

1. A data processing system for enabling a commercial order transaction between a customer and a merchant, the customer having a customer financial account with a financial service provider, the customer financial account having access to predefined funds, and having predefined customer confidential financial data, necessary to make payments therethrough, associated therewith, and the merchant having a predefined merchant financial account, and being authorized to receive payments from the financial service provider thereto; comprising:
first communication means for enabling the customer to communicate purchase data to the merchant, said purchase data being representative of at least: a desired order, customer data, and partial confidential financial data, representative of a portion of the predefined customer confidential financial data, that is sufficient, in conjunction with said customer data, to identify the customer to the financial service provider;
second communication means for providing, by the merchant to the financial service provider, order data, representative of: said purchase data, merchant data sufficient to identify the merchant and the predefined merchant financial account to the financial service provider, and charge data representative of a payment required by the merchant for said merchant order;
third communication means for establishing direct communication between the customer and the financial service provider;
authentication means for verifying, by the financial service provider during said direct communication, that the customer actually placed said desired order with the merchant; and
first control means for, when said desired order placement by the customer is verified by said authentication means, transmitting said required payment for said desired order through the customer financial account to the predefined merchant financial account, thereby enabling the merchant to fulfill said desired order.

2. The data processing system of claim 1, wherein said first communication means comprise at least one of: a customer interactive electronic system, a merchant interactive electronic system, and a communication link therebetween, operable in conjunction with one another, to enable the customer to electronically communicate said purchase data to the merchant.

3. The data processing system of claim 1, wherein said first communication means comprise at least one of: a customer communication system, a merchant communication system, and a communication link therebetween, operable in conjunction with one another, to enable the customer to verbally communicate said purchase data to the merchant.

4. The data processing system of claim 1, wherein said first communication means comprise at least one of: a written form representative of said purchase data and completed by the customer, a first form sending means, for sending said written form by the customer to the merchant, and a first form receiving means, for receiving said written form by the merchant from the customer.

5. The data processing system of claim 4, wherein said first form sending means comprise a customer facsimile system, wherein said first form receiving means comprise a merchant facsimile system, and wherein said customer facsimile system is operable to send said written form, and said merchant facsimile system is operable to receive said written form, as a facsimile transmission.

6. The data processing system of claim 1, further comprising means for enabling the customer to produce a written form representative of said purchase data, wherein said first communication means comprises one of the postal mail system, or a courier, and wherein during operation thereof, said written form is mailed by the customer to the merchant.

7. The data processing system of claim 6, further comprising form processing means for extracting said purchase data from said written form and for generating said order data for transmission to the financial service provider by said second communication means.

8. The data processing system of claim 1, wherein said authentication means further comprises fund verification means, for determining whether the predefined funds are sufficient to satisfy said required payment, and when the predefined funds are sufficient, causing said first control means to transfer a payment equal to said required payment amount through the customer financial account to the predefined merchant financial account, to enable the merchant to fulfill said desired order.

9. The data processing system of claim 8, wherein said authentication means further comprises denial means for rejecting, by the financial service provider, said required payment when the predefined funds are insufficient.

10. The data processing system of claim 9, wherein said authentication means further comprises first offer means, for offering during said direct communication, when the predefined funds are insufficient and prior to operation of said denial means, by the financial service provider to the customer, at least one assistance service configured such that acceptance of said at least one assistance service by the customer, results in said required payment being transmitted to the predefined merchant financial account, and refusal of said at least one assistance service by the customer, activates said denial means.

11. The data processing system of claim 1, wherein said authentication means further comprises second offer means, for offering during said direct communication, by the financial service provider to the customer, at least one service being marketed by the financial service provider or a business partner thereof.

12. The data processing system of claim 1, wherein said first and second communication means operate over the Internet, and wherein said third and fourth communication means operate over a telecommunication network.

13. The data processing system of claim 1, wherein during operation of said third communication means, said direct communication is initiated by the customer contacting the financial service provider.

14. The data processing system of claim 1, wherein during operation of said third communication means, said direct communication is initiated by financial service provider contacting the customer.

15. The data processing system of claim 1, wherein a configuration of said third communication means and said authentication means are predetermined by the financial service provider and the customer in conjunction with one another.

16. The data processing system of claim 1, wherein said third communication means comprises a customer communication device, and a financial service provider communication system, and wherein said customer communication device and said financial service provider communication system are operable to establish said direct communication, between the customer and the financial service provider, over a corresponding communication link.

17. The data processing system of claim 16, wherein said customer communication device is a telephone, wherein said financial service provider communication system is a telephone system, and wherein said corresponding communication link is a telecommunication network.

18. The data processing system of claim 1, wherein said authentication means further comprise identity verification means, for verifying the identity of the customer by the financial service provider during said direct communication, prior to verification of said desired order.

19. The data processing system of claim 1, wherein the merchant comprises a wireless service provider with which the customer has a predefined subscription account associated with a predefined mobile communication device, wherein said predefined subscription account includes the predefined customer confidential financial data previously submitted by the customer to said wireless service provider, and wherein said first communication means comprises said predefined mobile communication device, operable, by the customer, to send said purchase data to said wireless service provider in form of an electronic message.

20. The data processing system of claim 1, wherein the merchant comprises a mobile commerce-enabled merchant associated with a wireless service provider with which the customer has a predefined subscription account associated with a predefined mobile communication device, wherein said predefined subscription account includes the predefined customer confidential financial data previously submitted by the customer to said wireless service provider, wherein said first communication means comprises:
said predefined mobile communication device, operable, by the customer, to send said purchase data to said wireless service provider in form of an electronic message, and
forwarding means, for forwarding, by said wireless service provider to said mobile commerce-enabled merchant, said purchase data.

21. A data processing method for enabling a commercial order transaction between a customer and a merchant, the customer having a customer financial account with a financial service provider, the customer financial account having access to predefined funds, and having predefined customer confidential financial data, necessary to make payments therethrough, associated therewith, and the merchant having a predefined merchant financial account, and being authorized to receive payments from the financial service provider thereto, comprising the steps of:
(a) communicating, by the customer to the merchant, purchase data being representative of at least: a desired order, customer data, and partial confidential financial data, representative of a portion of the predefined customer confidential financial data, that is sufficient, in conjunction with said customer data, to identify the customer to the financial service provider;
(b) providing, by the merchant to the financial service provider, order data, representative of: said purchase data, merchant data sufficient to identify the merchant and the predefined merchant financial account to the financial service provider, and charge data representative of a payment required by the merchant for said merchant order;
(c) establishing direct communication between the customer and the financial service provider;
(d) verifying, by the financial service provider, during said direct communication, that the customer actually placed said desired order with the merchant; and
(e) when said desired order placement by the customer is verified at said step (d), transmitting said required payment for said desired order through the customer financial account to the predefined merchant financial account, thereby enabling the merchant to fulfill said desired order.

22. The data processing method of claim 21, further comprising the steps of:
(f) prior to said step (c), determining, by the financial service provider, whether the predefined funds are sufficient to satisfy said required payment; and
(g) when the predefined funds are sufficient, transmitting a preliminary order authorization to the merchant.

23. The data processing method of claim 22, further comprising the step of:
(h) when the predefined funds are not sufficient, transmitting a payment denial to at least one of: the merchant and the customer.

24. The data processing method of claim 23, further comprising the step of:
(i) when said step (h) has been performed, canceling said steps (d) and (e).

25. The data processing method of claim 22, further comprising the steps of:
(j) when the predefined funds are not sufficient, proceeding to said step (d), and then offering, by the financial service provider to the customer during said direct communication, at least one assistance service to enable the desired order to be completed based on the customer's acceptance thereof.

26. The data processing method of claim 25, further comprising the steps of:
(k) when the customer accepts said at least one assistance service, performing said at least one assistance service by the financial service provider, and proceeding to said step (e).

27. The data processing method of claim 25, further comprising the steps of:
(l) when the customer declines said at least one assistance service, transmitting a payment denial to at least one of: the merchant and the customer, and canceling said step (e).

28. The data processing method of claim 21, further comprising the steps of:
(m) offering, during performance of said step (d), by the financial service provider to the customer, at least one service being marketed by the financial service provider or a business partner thereof.

29. The data processing method of claim 21, wherein said step (d) is initiated by the customer contacting the financial service provider.

30. The data processing method of claim 21, wherein said step (d) is initiated by the financial service provider contacting the customer.

31. The data processing method of claim 21, further comprising the step of:
(n) prior to said step (a), determining, by the financial service provider and the customer in conjunction with one another, the manner in which said step (d) is performed.

32. The data processing method of claim 21, wherein said step (d) further comprises the step of:
(o) at the beginning of said direct communication, verifying, by the financial service provider, the identity of the customer.

33. The data processing method of claim 32, further comprising the step of:
(p) when the identity of the customer is not verified at said step (o), initiating a fraud investigation of the desired order and transmitting a payment denial to at least one of: the merchant and the customer.

34. The data processing method of claim 21, wherein the merchant comprises a wireless service provider with which the customer has a predefined subscription account associated with a predefined mobile communication device, wherein said predefined subscription account includes the predefined customer confidential financial data previously submitted by the customer to said wireless service provider, and wherein said step (a) comprises the step of:
(q) sending said purchase data, from said predefined mobile communication device to said wireless service provider, in form of an electronic message.

35. The data processing method of claim 34, further comprising the step of:
(t) at least partially performing said step (d), by the wireless service provider.

36. The data processing method of claim 21, wherein the merchant comprises a mobile commerce-enabled merchant associated with a wireless service provider with which the customer has a predefined subscription account for a predefined mobile communication device, wherein said predefined subscription account includes the predefined customer confidential financial data previously submitted by the customer to said wireless service provider, and wherein said step (a) comprises the steps of:
(r) sending said purchase data, from said predefined mobile communication device to said wireless service provider, in form of an electronic message; and
(s) forwarding said purchase data by said wireless service provider to said mobile commerce-enabled merchant.

37. The data processing method of claim 36, further comprising the step of:
(u) at least partially performing said step (d), by the wireless service provider.
